(19) United States
(12) Patent Application Publication
(10) Pub. No.: US 2023/0126048 A1
(43) Pub. Date: Apr. 27, 2023

(54) POST-PROCESSING DEVICE AND RECORDING SYSTEM

(71) Applicant: SEIKO EPSON CORPORATION, Tokyo (JP)

(72) Inventors: Masayoshi MIYAKAWA, Suwa-shi (JP); Hironori MATSUOKA, Matsumoto-shi (JP)

(21) Appl. No.: 18/048,926

(22) Filed: Oct. 24, 2022

(30) Foreign Application Priority Data
Oct. 26, 2021 (JP) 2021-174730

(51) Int. Cl. B41J 11/00

(52) U.S. Cl. CPC B41J 11/00212

(57) ABSTRACT

A controller can acquire, as information of a recording device, first information that can determine that a recording type of the recording device is an ink-jet type, and second information that can determine the recording type of the recording device is a laser type. The controller acquires the information of the recording device, performs the post-processing based on a first setting when the information of the recording device includes the first information capable of determining that the recording type is the ink-jet type, and performs the control of the post-processing based on a second setting different from the first setting when the information of the recording device includes the second information capable of determining that the recording type is the laser type.

The present application is based on, and claims priority from JP Application Serial Number 2021-174730, filed Oct. 26, 2021, the disclosure of which is hereby incorporated by reference herein in its entirety.

### BACKGROUND

### 1. Technical Field

The present disclosure relates to a post-processing device configured to perform post-processing on a medium on which recording was performed by a recording device and a recording system.

### 2. Related Art

For example, JP-A-2018-144911 discloses, as an example of a recording system, one including a recording device that performs recording on a medium, and a post-processing device that post-processes a medium on which recording was performed by the recording device. Ink-jet-type recording devices that perform recording on a medium using ink tend to incorporate more moisture into the medium after recording than that in laser type recording devices. Such a post-processing device performs specific control suitable for an ink-jet-type recording device in order to solve a problem that is unlikely to occur in a laser type recording device. For example, the post-processing device controls an operation of a paddle for matching media according to the number of media to be loaded in a processing tray for performing the post-processing. Thus, even when the medium after recording contains a large amount of moisture due to the ink-jet-type recording device, the matching of the medium can be improved.

However, in such a post-processing device and a recording system, when the recording device is replaced with a recording device having a different recording type, the post-processing device also has to be replaced corresponding to the recording type of the recording device. Thus, a user has to bear a work burden and a cost burden, and a manufacturer also has to manufacture and manage different post-processing devices corresponding to the recording types.

### SUMMARY

A post-processing device that solves the problem includes a reception part configured to receive a medium on which recording was performed by a recording device, a post-processing part configured to perform post-processing on the medium received by the reception part, and a controller configured to perform control of at least the post-processing, wherein the controller is configured to acquire, as information of the recording device, first information configured to determine that a recording type of the recording device is an ink-jet type, and second information configured to determine that the recording type of the recording device is a laser type, and the controller is configured to perform the control of at least the post-processing based on whether the first information is acquired or the second information is acquired.

A recording system that solves the problem includes a recording device configured to perform recording on a medium, and a post-processing device configured to receive the medium on which the recording was performed by the recording device, wherein the post-processing device includes a reception part configured to receive the medium on which the recording was performed by the recording device, a post-processing part configured to perform post-processing on the medium received by the reception part, and a controller configured to perform control of at least the post-processing, the controller is configured to acquire, as information of the recording device, first information configured to determine that a recording type of the recording device is an ink-jet type, and second information configured to determine that the recording type of the recording device is a laser type, and the controller is configured to acquire the information of the recording device, to perform the post-processing based on a first setting when the information of the recording device includes the first information configured to determine that the recording type is an ink-jet type, and to perform control of the post-processing based on a second setting different from the first setting when the information of the recording device includes the second information configured to determine that the recording type is a laser type.

### BRIEF DESCRIPTION OF THE DRAWINGS

FIG. 1 is a side view schematically illustrating a recording system including a post-processing device.

FIG. 2 is an enlarged view of FIG. 1 illustrating a post-processing device.

FIG. 3 is a schematic diagram illustrating a setting information table.

FIG. 4 is a schematic diagram illustrating a paddle rotation table.

FIG. 5 is a flowchart illustrating a recording control setting process.

FIG. 6 is a schematic diagram of a recordable region and a punching region on a medium.

FIG. 7 is a schematic diagram of a recordable region, a punching region, and a restriction region on a medium.

FIG. 8 is a schematic diagram of the recordable region, the punching region, and the restriction region on a medium.

FIG. 9 is a schematic diagram of the recordable region, the punching region, and the restriction region on a medium.

FIG. 10 is a schematic diagram of the recordable region, the punching region, and the restriction region on a medium.

FIG. 11 is a schematic diagram of the recordable region, the punching region, and the restriction region on a medium.

FIG. 12 is a flowchart illustrating a post-processing control setting process.

FIG. 13 is a flowchart illustrating a matching control process.

### DESCRIPTION OF EXEMPLARY EMBODIMENTS

Embodiments

Hereinafter, an embodiment of a recording system including a post-processing device will be described. The recording system performs, for example, a recording operation in which recording is performed on a medium and a post-processing operation in which post-processing is performed on the medium on which recording was performed.

Recording System

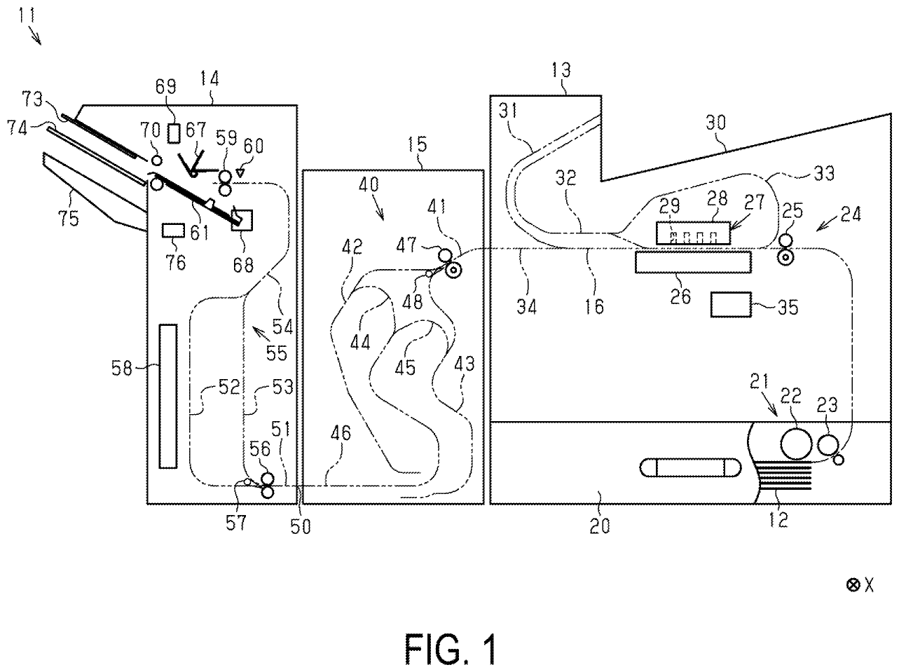

As illustrated in FIG. 1, a recording system 11 includes a recording device 13 configured to perform recording on a medium 12. The recording system 11 includes a post-processing device 14. The post-processing device 14 performs post-processing on the medium 12 on which recording was performed by the recording device 13. The recording system 11 may include an intermediate device 15. The intermediate device 15 is disposed between the recording device 13 and the post-processing device 14. The intermediate device 15 transports the medium 12, on which recording was performed by the recording device 13, to the post-processing device 14.

The recording system 11 includes a transport path 16. The transport path 16 is a path that continues from the recording device 13 to the inside of the post-processing device 14 via the intermediate device 15. The recording system 11 includes a plurality of transport roller pairs. The plurality of transport roller pairs transport a medium 12 along the transport path 16. For example, at least one or more transport roller pairs are provided at each of the recording device 13, the intermediate device 15, and the post-processing device 14. In the present embodiment, a direction in which an axis of the transport roller pair extends is referred to as an axial direction X.

Recording Device

The recording device 13 is configured to perform recording on the medium 12. The recording device 13 of the present embodiment is an ink-jet-type printer that records an image by discharging ink, which is an example of a liquid, onto the medium 12. The recording device 13 according to the present embodiment may be a laser type printer that records an image by attaching toner using a laser beam. That is, to the recording device 13, whether a recording type is an ink-jet type or a laser type does not matter. The image is formed by a liquid attached to the medium 12. The Image includes photographs, patterns, letters, symbols, marks, lines, tables and the like.

The recording device 13 includes a cassette 20. The cassette 20 accommodates the medium 12 in a stacked state. The cassette 20 is detachably provided in the recording device 13. A plurality of cassettes 20 may be provided.

The recording device 13 includes a paper feed mechanism 21. The paper feed mechanism 21 is configured to feed the medium 12 to a recording part 27. The paper feed mechanism 21 delivers the medium 12 accommodated in the cassette 20 to the transport path 16. The paper feed mechanism 21 may include a pickup roller 22 and a separation roller 23. The pickup roller 22 sends the uppermost medium 12 of the media 12 accommodated in the cassette 20. The separation roller 23 separates the sheets of medium 12 sent out by the pickup roller 22 one by one.

The recording device 13 includes a first transport mechanism 24. The first transport mechanism 24 transports the medium 12 fed by the paper feed mechanism 21 along the transport path 16. The first transport mechanism 24 is configured to transport the medium 12 on which recording was performed by the recording part 27. In the present embodiment, the first transport mechanism 24 corresponds to an example of a recording transport mechanism. The first transport mechanism 24 includes a plurality of first transport roller pairs 25. The plurality of first transport roller pairs 25 are transport roller pairs provided in the recording device 13. The plurality of first transport roller pairs 25 are disposed along the transport path 16. In FIG. 1, one of the plurality of first transport roller pairs 25 is illustrated in a representative manner. The plurality of first transport roller pairs 25 transports the medium 12 fed from the cassette 20 along the transport path 16 in the recording device 13.

The recording device 13 includes a support part 26. The support part 26 is provided at a position along the transport path 16. The support part 26 supports the medium 12.

The recording device 13 includes the recording part 27. The recording part 27 is configured to perform recording on the medium 12. The recording part 27 is provided at a position facing the support part 26 with the transport path 16 interposed therebetween. The recording part 27 includes a liquid discharging head 28. The liquid discharging head 28 includes a plurality of nozzles 29 that discharge liquid. The liquid discharging head 28 performs recording on the medium 12 by discharging liquid from the nozzles 29 toward the medium 12 supported by the support part 26.

The liquid discharging head 28 of the present embodiment is a line head having, for example, a plurality of nozzles 29 arranged at a constant pitch in the axial direction X and capable of simultaneously discharging liquid over a width of the medium 12. The liquid discharging head 28 may be a serial head that is mounted on a carriage configured to move in the axial direction X and a direction opposite thereto and discharges liquid while moving together with the carriage.

The recording device 13 includes a placement tray 30. The medium 12 discharged from the inside of the recording device 13 is placed in the placement tray 30. The recording device 13 has a first discharge path 31, a switch back path 32, an inversion path 33, and a second discharge path 34 as part of the transport path 16. The first discharge path 31 is a path through which the medium 12 is discharged. The medium 12 discharged from the first discharge path 31 is placed in the placement tray 30. The switch back path 32 is a path through which the medium 12 is switched back. The inversion path 33 is a path through which the front and back of the medium 12 are inverted. The second discharge path 34 is a path through which the medium 12 is discharged. The medium 12 discharged from the second discharge path 34 is transported to the intermediate device 15. In this way, the medium 12 on which recording was performed by the liquid discharging head 28 is discharged to the placement tray 30 through the first discharge path 31, or is transported through the second discharge path 34 toward the intermediate device 15.

When double-sided recording is performed, the medium 12 on which recording was performed on one side is transported to the switch back path 32 and then switched back in the switch back path 32. Thus, the medium 12 on which recording was performed on one side is transported from the switch back path 32 to the inversion path 33. The medium 12 inverted in the inversion path 33 is again transported to the liquid discharging head 28, and then recording is performed on a surface opposite to the surface on which recording has been already performed by the liquid discharging head 28. In this way, the recording device 13 performs the double-sided recording on the medium 12.

The recording device 13 includes a recording controller 35. The recording controller 35 may comprehensively control driving of each mechanism in the recording device 13 and may control various operations performed in the recording device 13. The recording controller 35 may include one or more processors that perform various processes according to a computer program, one or more dedicated hardware circuits, such as an application-specific integrated circuit, that performs at least some of the various processes, or a combination thereof. The processor includes a CPU and a memory such as RAM and ROM, and the memory stores a program code or a command configured to cause the CPU to perform the process. The memory, that is, a computer readable medium includes all kinds of readable media accessible by a general purpose or dedicated computer.

The recording controller 35 can communicate with the intermediate device 15 via a communication part (not illustrated). The recording controller 35 can communicate with the post-processing device 14 via a communication part (not illustrated). In the present embodiment, the recording controller 35 can transmit information of post-processing to the post-processing device 14 when a recording command involving the post-processing is input. The information of the post-processing includes the number of processing sheets on which the post-processing is performed. The number of processing sheets is the number of sheets per unit in which the post-processing is performed. When a recording type of the recording device 13 is an ink-jet type, when the recording command involving the post-processing is input, recording density information that can determine a recording density on the medium 12 can be transmitted to the post-processing device 14 by the recording controller 35. The recording density is a ratio of an area for recording an image to an area of the medium 12. In other words, the recording density is a ratio of the number of dots of liquid actually driven into the medium 12 to the maximum number of dots of liquid able to be driven thereinto. In this way, the recording controller 35 is configured to perform control of at least the recording on the medium 12.

Intermediate Device

The intermediate device 15 is a device for discharging the medium 12 after recording that has been carried in from the recording device 13 to the post-processing device 14. The intermediate device 15 may include an inversion processing part 40. The inversion processing part 40 inverts the carried-in medium 12.

The inversion processing part 40 may have a first introduction path 41, a first switch back path 42, a second switch back path 43, a first joining path 44, a second joining path 45, and a lead-out path 46 as part of the transport path 16.

The inversion processing part 40 may include a plurality of second transport roller pairs 47. The plurality of second transport roller pairs 47 are transport roller pairs provided in the intermediate device 15. The plurality of second transport roller pairs 47 are disposed along the transport path 16. In FIG. 1, one of the plurality of second transport roller pairs 47 is illustrated in a representative manner.

The inversion processing part 40 may include a first flap 48. The first flap 48 guides the medium 12 to either one of the first switch back path 42 and the second switch back path 43 at a branch location at which the first introduction path 41 branches to the first switch back path 42 and the second switch back path 43. In this manner, the first flap 48 switches a transport destination of the medium 12 transported from the first introduction path 41 between the first switch back path 42 and the second switch back path 43.

The medium 12 transported to the first switch back path 42 is inverted in the first joining path 44 by being switched back in the first switch back path 42 and is then transported to the lead-out path 46. On the other hand, the medium 12 transported from the first introduction path 41 to the second switch back path 43 is inverted in the second joining path 45 by being switched back in the second switch back path 43, and is then transported to the lead-out path 46. The intermediate device 15 can cause the medium 12 to be alternately carried into the first switch back path 42 and the second switch back path 43, for example.

Post-Processing Device

The post-processing device 14 is a device that performs post-processing on the medium 12 after recording that is carried in from the intermediate device 15. In other words, the post-processing device 14 can receive the medium 12 on which recording was performed by the recording device 13, and is configured to perform the post-processing on the received medium 12.

The post-processing device 14 includes a reception part 50. The reception part 50 is provided in the transport path 16. The reception part 50 is configured to receive the medium 12 carried in from the intermediate device 15. In this way, the reception part 50 can receive the medium 12 on which recording was performed by the recording device 13.

The post-processing device 14 may have a second introduction path 51, a first transport path 52, a second transport path 53, and a joining path 54 as part of the transport path 16. The second introduction path 51, the first transport path 52, the second transport path 53, and the joining path 54 are paths configured to transport the medium 12 before the post-processing is performed. The second introduction path 51 is a path configured to transport the medium 12 received from the reception part 50. The first transport path 52 and the second transport path 53 are paths that branch from the second introduction path 51. The first transport path 52 and the second transport path 53 are paths configured to transport the medium 12 from the second introduction path 51. The first transport path 52 has a longer path length than the second transport path 53. The joining path 54 is a path that joins the first transport path 52 and the second transport path 53. The joining path 54 is a path configured to transport the medium 12 from the first transport path 52 and the second transport path 53.

The post-processing device 14 includes a second transport mechanism 55. The second transport mechanism 55 is configured to transport the medium 12 after recording that is received by the reception part 50. In the present embodiment, the second transport mechanism 55 corresponds to an example of a post-processing transport mechanism. The second transport mechanism 55 may include a plurality of third transport roller pairs 56. The plurality of third transport roller pairs 56 are transport roller pairs provided in the post-processing device 14. The plurality of third transport roller pairs 56 are disposed along the transport path 16. In FIG. 1, one of the plurality of third transport roller pairs 56 is illustrated in a representative manner.

The second transport mechanism 55 may include a second flap 57. The second flap 57 guides the medium 12 to either one of the first transport path 52 and the second transport path 53 at a branch location that branches from the second introduction path 51 to the first transport path 52 and the second transport path 53. In this way, the second flap 57 switches a transport destination of the medium 12 transported from the second introduction path 51 between the first transport path 52 and the second transport path 53.

In this way, the medium 12 received in the reception part 50 may be transported through the second introduction path 51, the first transport path 52, and the joining path 54, and may be transported through the second introduction path 51, the second transport path 53, and the joining path 54. The first transport path 52 has a longer path length than the second transport path 53. Therefore, when the medium 12 is transported through the first transport path 52, a transport time in which the medium 12 is transported through the post-processing device 14 is longer than in the case in which the medium 12 is transported through the second transport path 53. Thus, a drying time of the medium 12 can be ensured.

In the present embodiment, the post-processing device 14 transports the medium 12 at a predetermined transport speed in the transport path 16 inside the post-processing device 14. The post-processing device 14 can stop transport of the medium 12 in the transport path 16 inside the post-processing device 14 for a predetermined time and can cause the medium 12 to wait. In this way, the transport path 16 inside the post-processing device 14 is configured to cause the medium 12 before the post-processing is performed to wait. Thus, the drying time of the medium 12 can be ensured. In the present embodiment, the transport path 16 inside the post-processing device 14 corresponds to an example of a waiting part.

The post-processing device 14 includes a drying mechanism 58. The drying mechanism 58 may be provided at a position along the first transport path 52. The drying mechanism 58 dries the medium 12 transported through the first transport path 52. The drying mechanism 58 may dry the medium 12 transported to a post-processing part 68. The drying mechanism 58 may not be provided at a position along the second transport path 53 and may not dry the medium 12 transported through the second transport path 53. In this way, when the medium 12 is transported through the first transport path 52, the medium 12 can be dried by the drying mechanism 58 as compared with a case in which the medium 12 is transported through the second transport path 53.

The second transport mechanism 55 may include a fourth transport roller pair 59. The fourth transport roller pair 59 is a transport roller pair provided in the post-processing device 14. The fourth transport roller pair 59 is provided at an end of the transport path 16.

The post-processing device 14 includes a sensor 60 disposed downstream of the fourth transport roller pair 59 in the transport path 16. The sensor 60 detects a leading end and a trailing end of the carried-in medium 12. In the present embodiment, when the trailing end of the medium 12 passes through the fourth transport roller pair 59, the medium 12 falls from the fourth transport roller pair 59.

Details of Post-Processing Device

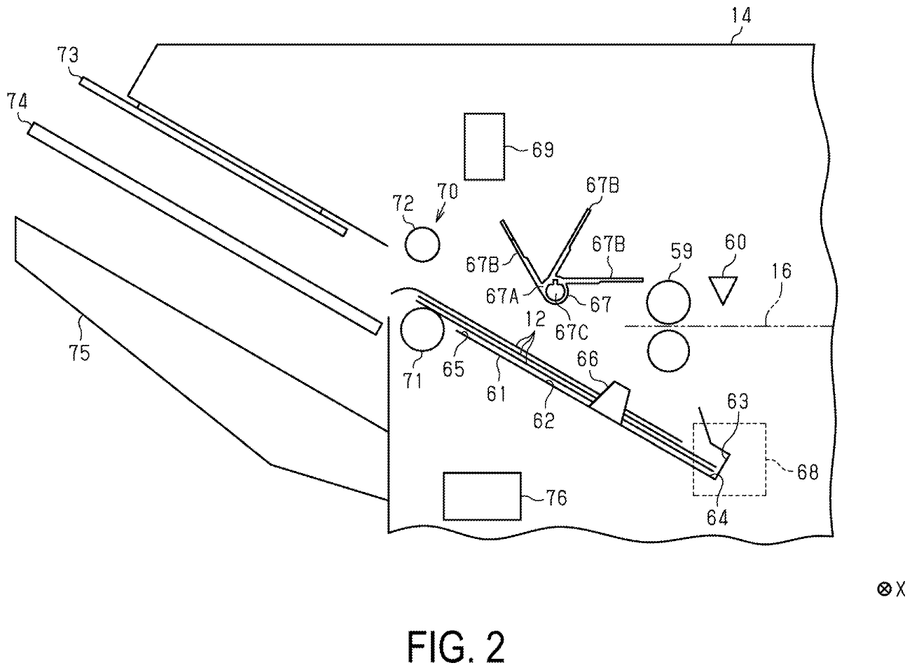

As illustrated in FIG. 2, the post-processing device 14 may include a processing tray 61. The processing tray 61 is a tray in which the medium 12 transported by the plurality of third transport roller pairs 56 and the fourth transport roller pair 59 is loaded. That is, the processing tray 61 is a tray in which the medium 12 on which recording was performed is loaded. Further, the processing tray 61 can load the medium 12 on which the post-processing is performed.

The processing tray 61 is located below the fourth transport roller pair 59. Therefore, the processing tray 61 receives the medium 12 falling from the fourth transport roller pair 59. Thus, the medium 12 is loaded on the processing tray 61. At this time, the medium 12 may be loaded into the processing tray 61 so that the leading end of the medium 12 protrudes from the processing tray 61.

The processing tray 61 has a loading surface 62 on which the medium 12 is loaded, and a contact surface 63 with which the trailing end of the loaded medium 12 is in contact. The loading surface 62 is connected to the contact surface 63. The loading surface 62 has a first end portion 64 which is an end portion connected to the contact surface 63, and a second end portion 65 opposite to the first end portion 64. The loading surface 62 is inclined to extend upward from the first end portion 64 toward the second end portion 65. That is, the first end portion 64 is located below the second end portion 65.

The contact surface 63 is a surface with which the trailing end of the medium 12 loaded on the processing tray 61 comes into contact. In the present embodiment, since the loading surface 62 is inclined to extend upward from the first end portion 64 to the second end portion 65, the medium 12 loaded on the loading surface 62 is easily slid toward the contact surface 63 due to an action of gravity. Therefore, the trailing end of the medium 12 easily comes into contact with the contact surface 63. When the trailing end of the medium 12 comes into contact with the contact surface 63, the trailing end of the medium 12 is aligned with the contact surface 63 as a reference. When a size of each of the plurality of media 12 to be loaded is the same, the leading end of the medium 12 is aligned due to the alignment of the trailing end of the medium 12. Thus, the leading end and the trailing end of the medium 12 are matched.

In the present embodiment, the processing tray 61 includes a pair of edge guides 66 arranged in the axial direction X. The pair of edge guides 66 are configured to move in the axial direction X and the direction opposite thereto. The pair of edge guides 66 can be moved to widen or narrow an interval therebetween. The pair of edge guides 66 match the medium 12 by coming into contact with both side ends of the medium 12 loaded on the loading surface 62. The side ends of the medium 12 are two ends excluding the leading end and the trailing end of the rectangular medium 12. Due to the contact surface 63 and the pair of edge guides 66 coming into contact with the medium 12, the leading end, the trailing end, and the side ends of the medium 12 are aligned. As a result, the medium 12 is matched.

The post-processing device 14 may include a paddle 67. The paddle 67 is located, for example, above the processing tray 61. The paddle 67 includes a rotation body 67A, a blade 67B, and a rotating shaft 67C. The rotation body 67A is supported by the rotating shaft 67C. The rotation body 67A rotates about the rotating shaft 67C. The rotating shaft 67C extends in the axial direction X. The blade 67B extends outward from rotation body 67A. One or more blades 67B are provided. In the present embodiment, three blades 67B are provided. The blade 67B is made of an elastic material such as rubber or elastomer. The blade 67B is provided in a plate shape, for example.

A tip end portion of the blade 67B comes into contact with the medium 12 loaded on the processing tray 61. When the rotation body 67A rotates in a state in which the tip end portion of the blade 67B is in contact with the medium 12 loaded on the processing tray 61, the blade 67B bends. Due to a reaction force of the bending, a frictional force is generated between the tip end portion of the blade 67B and the medium 12.

The paddle 67 pulls the medium 12 into the processing tray 61 due to the frictional force between the tip end portion of the blade 67B and the medium 12. That is, the paddle 67 rotates to send the medium 12 toward the contact surface 63. Therefore, the paddle 67 rotates counterclockwise in FIG. 2. In this way, the paddle 67 is a drawing member that comes into contact with the medium 12 on the processing tray 61 by rotating and draws the medium 12 into the processing tray 61.

In this way, in the present embodiment, the paddle 67 corresponds to an example of a rotary transport part configured to transport the medium 12 loaded on the processing tray 61 by rotating in a state in which the paddle 67 is in contact with the medium 12 loaded on the processing tray 61.

The post-processing device 14 includes the post-processing part 68. The post-processing part 68 is configured to perform post-processing on the medium 12 loaded on the processing tray 61. In other words, the post-processing part 68 is configured to perform the post-processing on the medium 12 received in the reception part 50. The post-processing is, for example, a binding process for binding a plurality of media 12, but may also be a punching process, a folding process, a matching process, a shift process, a bar loading process, or the like, in addition to the binding process. The punching process is a process of punching one or more sheets of media 12. The folding process is a process of folding the medium 12. The matching process is a process of matching the end portion of the medium 12. The shift processing is a process for shifting a position of the medium 12 and discharging the medium 12 for each part. The bar loading process is a process for discharging the medium 12 in unit of part without shifting a position thereof. The post-processing part 68 is, for example, a binding mechanism for performing the binding process, but may also be a punching mechanism, a folding mechanism, a side cursor mechanism, or the like. The side cursor mechanism is a mechanism that matches a width direction of the medium 12. In this way, the post-processing part 68 may be able to perform the binding process for binding the plurality of media 12 as the post-processing. The post-processing part 68 may be able to perform the punching process on the one or more sheets of medial2 as the post-processing.

The post-processing device 14 may include an air blowing part 69. The air blowing part 69 is provided above the processing tray 61. The air blowing part 69 is provided to face the loading surface 62 of the processing tray 61. The air blowing part 69 can blow air to the medium 12 loaded on the processing tray 61. In this way, the air blowing part 69 is configured to blow air from above the processing tray 61 toward the medium 12 loaded on the processing tray 61.

The post-processing device 14 may include a discharging part 70. The discharging part 70 includes, for example, a driving roller 71 and a driven roller 72. The driving roller 71 comes into contact with the medium 12 loaded on the processing tray 61 from below. The driven roller 72 is located above the driving roller 71. In the present embodiment, the driven roller 72 is configured to be movable. The driven roller 72 approaches or separates from the driving roller 71. The driven roller 72 comes into contact with the medium 12 by approaching the driving roller 71. At this time, the driven roller 72 comes into contact with the medium 12 loaded on the processing tray 61 from above.

The discharging part 70 discharges the medium 12 by rotating the driving roller 71 in a state in which the medium 12 loaded on the processing tray 61 is sandwiched between the driving roller 71 and the driven roller 72. In this way, the discharging part 70 discharges the medium 12 subjected to the post-processing from the processing tray 61.

The post-processing device 14 may include a guide part 73, a pair of support members 74, and a discharge stacker 75. The guide part 73 is provided in a plate shape, for example. The guide part 73 suppresses an upward displacement of the medium 12 by coming into contact with the medium 12 discharged by the discharging part 70.

The pair of support members 74 are located below the guide part 73. The pair of support members 74 are arranged in the axial direction X. The pair of support members 74 temporarily supports the medium 12 discharged by the discharging part 70. The pair of support members 74 supports the medium 12 by coming into contact with the side end portions of the medium 12. The pair of support members 74 are configured to be movable in the axial direction X and the direction opposite thereto. That is, the pair of support members 74 can be configured to widen or narrow an interval therebetween. The pair of support members 74 support the side end portions of the medium 12 by adjusting the interval therebetween to a width of the medium 12. The pair of support members 74 fall the supported medium 12 by widening the interval in a state in which the medium 12 is supported. The pair of support members 74 may support the leading end of the medium 12 not only when the medium 12 is discharged from the processing tray 61 by the discharging part 70 but also when the medium 12 falls from the fourth transport roller pair 59 to the processing tray 61.

The discharge stacker 75 is located below the pair of support members 74. The medium 12 falling from the pair of support members 74 is placed on the discharge stacker 75. The discharge stacker 75 may move up and down according to an amount of loaded medium 12. In the present embodiment, the pair of support members 74 and the discharge stacker 75 correspond to an example of a placement part on which the medium 12 after the post-processing is performed can be placed.

The post-processing device 14 includes a post-processing controller 76. The post-processing controller 76 may comprehensively control driving of each mechanism in the post-processing device 14 and may control various operations performed by the post-processing device 14. The post-processing controller 76 may include one or more processors that perform various processes according to a computer program, one or more dedicated hardware circuits, such as an application-specific integrated circuit, that performs at least some of the various processes, or a combination thereof. The processor includes a CPU and a memory such as RAM and ROM, and the memory stores a program code or a command configured to cause the CPU to perform the process. The memory, that is, a computer readable medium includes all kinds of readable media accessible by a general purpose or dedicated computer. The post-processing controller 76 can communicate with the recording device 13 via a communication part (not illustrated). In this way, the post-processing controller 76 is configured to perform control of at least the post-processing. The post-processing controller 76 of the present embodiment corresponds to an example of a controller.

In the present embodiment, the post-processing controller 76 receives, from the recording device 13, information that can determine a recording type of the recording device 13 and a model of the recording device 13 when power is turned on. Thus, the post-processing controller 76 can determine the recording type of the recording device 13 and the model of the recording device 13.

Setting Information Table

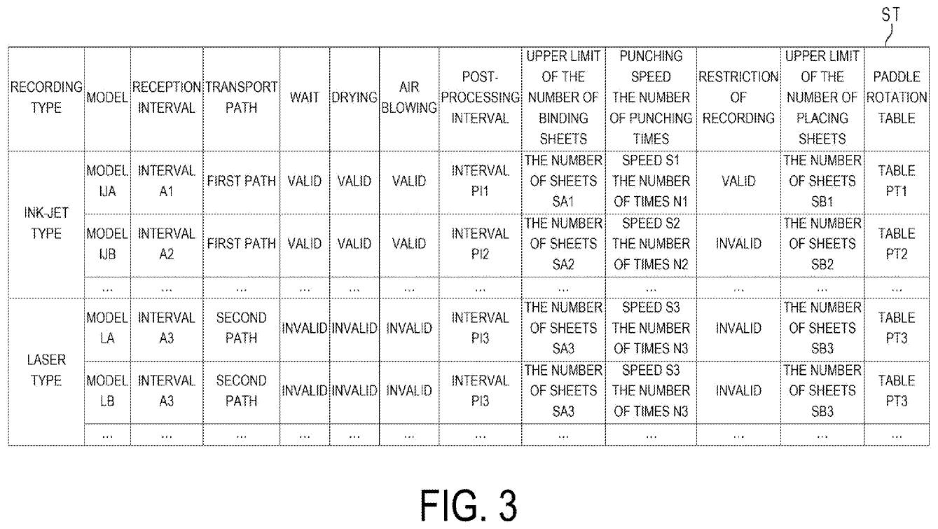

As illustrated in FIG. 3, the post-processing controller 76 stores a setting information table ST in the memory. The setting information table ST is a table in which setting information corresponding to the recording type of the recording device 13 and the model of the recording device 13 is stored.

The recording type of the recording device 13 includes an ink-jet type and a laser type. The model of the recording device 13 corresponds to the recording type of the recording device 13. Specifically, a model IJA corresponds to the ink-jet type as the recording type of the recording device 13. A model IJB is corresponds to the ink-jet type as the recording type of the recording device 13. A model LA corresponds to the laser type as the recording type of the recording device 13. A model LB corresponds to the laser type as the recording type of the recording device 13.

The model of the recording device 13 corresponds to the setting information for performing control related to the post-processing. In other words, the recording type of the recording device 13 corresponds to the setting information for performing control related to the post-processing.

The setting information may include information that can determine a reception interval. The reception interval is an interval that allows the reception part 50 to receive the medium 12. Specifically, the model IJA corresponds to an interval AI1 as the reception interval. The type IJB corresponds to an interval AI2 as the reception interval. The model LA corresponds to an interval AI3 as the reception interval. The model LB corresponds to the interval AI3 as the reception interval. The interval AI1 is longer than the interval AI2. The interval AI2 is longer than the interval AI3. Thus, the model IJA and the model IJB which are the ink-jet type recording devices 13 have a longer reception interval than the model LA and the model LB which are laser type recording devices 13. Similarly, in the ink-jet type recording devices 13, the reception interval of the model IJA is longer than that of the model IJB. Similarly, in the laser type recording devicesl3, the reception intervals of the model LA and the model LB are the same. In this way, the post-processing controller 76 can determine the reception interval corresponding to the recording type of the recording device 13 and the model of the recording device 13.

The setting information may include information that can determine a transport path for transporting the medium 12 within the post-processing device 14. The transport path includes a transport path through the first transport path 52 and a transport path through the second transport path 53. Specifically, the model IJA corresponds to the transport path through the first transport path 52. The model IJB corresponds to the transport path through the first transport path 52. The model LA corresponds to the transport path through the second transport path 53. The model LB corresponds to the transport path through the second transport path 53. The transport path through the first transport path 52 has a longer path length than the transport path through the second transport path 53. Thus, the model IJA and the model IJB which are the ink-jet type recording devices 13 have a longer path length of the transport path than the model LA and the model LB which are the laser type recording devices 13. Similarly, in the ink-jet type recording device 13, the path length of the transport path is the same in the model IJA and the model IJB. Similarly, in the laser type recording device 13, the path length of the transport path is the same in the model LA and the model LB. In this way, the post-processing controller 76 can determine the transport path corresponding to the recording type of the recording device 13 and the model of the recording device 13.

The setting information may include information that can determine whether waiting of the medium 12 in the post-processing device 14 is valid or invalid. Specifically, in the model IJA, the waiting of the medium 12 in the post-processing device 14 is valid. In the model IJB, the waiting of the medium 12 in the post-processing device 14 is valid. In the model LA, the waiting of the medium 12 in the post-processing device 14 is invalid. In the model LB, the waiting of the medium 12 in the post-processing device 14 is invalid. Thus, in the case of the model IJA and the model IJB which are the ink-jet type recording devices 13, the medium 12 may wait in the transport path 16 in the post-processing device 14. In the case of the model LA and the model LB which are the laser type recording devices 13, the medium 12 does not wait in the transport path 16 in the post-processing device 14. In this way, the post-processing controller 76 can determine whether the waiting of the medium 12 in the post-processing device 14 is valid or invalid corresponding to the recording type of the recording device 13 and the model of the recording device 13.

The setting information may include information that can determine whether drying by the drying mechanism 58 is valid or invalid. Specifically, in the model IJA, the drying by the drying mechanism 58 is valid. In the model IJB, the drying by the drying mechanism 58 is valid. In the model LA, the drying by the drying mechanism 58 is invalid. In the model LB, the drying by the drying mechanism 58 is invalid. Therefore, in the case of the model IJA and the model IJB which are the ink-jet type recording devices 13, the drying by the drying mechanism 58 is performed. In the case of the model LA and the model LB which are the laser type recording devices 13, the drying by the drying mechanism 58 is not performed. In this way, the post-processing controller 76 can determine whether the drying by the drying mechanism 58 is valid or invalid corresponding to the recording type of the recording device 13 and the model of the recording device 13.

The setting information may include information that can determine whether or not air-blowing by the air blowing part 69 is valid or invalid. Specifically, in the model IJA, the air-blowing by the air blowing part 69 is valid. In the model IJB, the air-blowing by the air blowing part 69 is valid. In the model LA, the air-blowing by the air blowing part 69 is invalid. In the model LB, the air-blowing by the air blowing part 69 is invalid. Therefore, in the case of the model IJA and the model IJB which are the ink-jet type recording devices 13, the air-blowing by the air blowing part 69 is performed. In the case of the model LA and the model LB which are the laser type recording devices 13, the air-blowing by the air blowing part 69 is not performed. In this way, the post-processing controller 76 can determine whether the air-blowing by the air blowing part 69 is valid or invalid corresponding to the recording type of the recording device 13 and the model of the recording device 13.

The setting information may include information that can determine a post-processing interval. The post-processing interval is an interval that allows the post-processing part 68 to perform the post-processing. The post-processing interval is based on a case in which the number of sheets of the medium 12 as a reference for performing the post-processing is a predetermined number. Specifically, the model IJA corresponds to an interval PI1 as the post-processing interval. The model IJB corresponds to an interval PI2 as the post-processing interval. The model LA corresponds to an interval PI3 as the post-processing interval. The model LB corresponds to the interval PI3 as a post-processing interval. The interval PI1 is longer than the interval PI2. The interval PI2 is longer than the interval PI3. Thus, the model IJA and the model IJB which are the ink-jet type recording devices 13 have a longer post-processing interval than the model LA and the model LB which are laser type recording devices 13. Similarly, even in the ink-jet type recording devices 13, the model IJA has a longer post-processing interval than the model IJB. Similarly, in the laser type recording devices 13, the same post-processing interval is used in the model LA and the model LB. In this way, the post-processing controller 76 can determine the post-processing interval corresponding to the recording type of the recording device 13 and the model of the recording device 13.

The setting information may include information that can determine the upper limit of the number of binding sheets. The upper limit of the number of binding sheets is an upper limit of the number of media 12 that can be bound by the post-processing part 68 performing the binding process. Specifically, the model IJA corresponds to the number of sheets SA1 as the upper limit of the number of binding sheets. The model IJB corresponds to the number of sheets SA2 as the upper limit of the number of binding sheets. The model LA corresponds to the number of sheets SA3 as the upper limit of the number of binding sheets. The model LB corresponds to the number of sheets SA3 as the upper limit of the number of binding sheets. The number of sheets SA1 is less than the number of sheets SA2. The number of sheets SA2 is less than the number of the sheets SA3. Therefore, the model IJA and the model IJB which are the ink-jet type recording devices 13 have a smaller upper limit of the number of binding sheets than the model LA and the model LB which are the laser type recording devices 13. Similarly, even in the ink-jet type recording devices 13, the upper limit of the number of binding sheets in the model IJA is less than that in the model IJB. Similarly, in the laser type recording devices 13, the upper limit of the number of binding sheets is the same between the model LA and the model LB. In this way, the post-processing controller 76 can determine the upper limit of the number of binding sheets corresponding to the recording type of the recording device 13 and the model of the recording device 13.

The setting information may include information that can determine a punching speed. The punching speed is a speed at which the post-processing part 68 performs the punching process. Specifically, the model IJA corresponds to a speed S1 as the punching speed. The model IJB corresponds to a speed S2 as the punching speed. The model LA corresponds to a speed S3 as the punching speed. The model LB corresponds to the speed S3 as the punching speed. The speed S1 is faster than the speed S2. The speed S2 is faster than the speed S3. Thus, the model IJA and the model IJB which are the ink-jet type recording devices 13 have a faster punching speed than the model LA and the model LB which are the laser type recording devices 13. Similarly, even in the ink-jet type recording devices 13, the punching speed of the model IJA is faster than that of the model IJB. Similarly, in the laser type recording devices 13, the punching speed is the same between the model LA and the model LB. In this way, the post-processing controller 76 can determine the punching speed corresponding to the recording type of the recording device 13 and the model of the recording device 13.

The setting information may include information that can determine the number of punching times. The number of punching times is the number of times the post-processing part 68 performs the punching process. Specifically, the model IJA corresponds to the number of times N1 as the number of punching times. The model IJB corresponds to the number of times N2 as the number of punching times. The model LA corresponds to the number of times N3 as the number of punching times. The model LB corresponds to the number of times N3 as the number of punching times. The number of times N1 is greater than the number of times N2. The number of times N2 is greater than the number of times N3. Therefore, the model IJA and the model IJB which are the ink-jet type recording devices 13 have the greater number of punching times than the model LA and the model LB which are the laser type recording devices 13. Similarly, even in the ink-jet type recording devices 13, the model IJA has the number of punching times greater than that of the model IJB. Similarly, in the laser type recording devices 13, the number of punching times is the same between the model LA and the model LB. In this way, the post-processing controller 76 can determine the number of punching times corresponding to the recording type of the recording device 13 and the model of the recording device 13.

The setting information may include information that can determine whether restriction of recording in a restriction region on the medium 12 is valid or invalid. Specifically, in the model IJA, the restriction of recording on the medium 12 is valid. In the model IJB, the restriction of recording on the medium 12 is valid. In the model LA, the restriction of recording on the medium 12 is invalid. In the model LB, the restriction of recording on the medium 12 is invalid. Thus, in the case of the model IJA and the model IJB which are the ink-jet type recording devices 13, the recording on the medium 12 is restricted by the recording part 27. In the case of the model LA and the model LB which are the laser type recording devices 13, the recording on the medium 12 is not restricted by the recording part 27. In this way, the post-processing controller 76 can determine whether or not the restriction of recording on the medium 12 is valid or invalid corresponding to the recording type of the recording device 13 and the model of the recording device 13. As will be described in detail below, the post-processing controller 76 can transmit, to the recording device 13, recording restriction information that can identify the restriction of the recording in the restriction region on the medium 12.

The setting information may include information that can determine the upper limit of the number of placing sheets. The upper limit of the number of placing sheets is the upper limit of the number of the media 12 that can be placed on the pair of support members 74 and the discharge stacker 75. Specifically, the model IJA corresponds to the number of sheets SB1 as the upper limit of the number of placing sheets. The model IJB corresponds to the number of sheets SB2 as the upper limit of the number of placing sheets. The model LA corresponds to the number of sheets SB3 as the upper limit of the number of placing sheets. The model LB corresponds to the number of sheets SB3 as the upper limit of the number of placing sheets. The number of sheets SB1 is less than the number of sheets SB2. The number of sheets SB2 is less than the number of sheets SB3. Thus, the model IJA and the model IJB which are the ink-jet type recording devices 13 have a smaller upper limit of the number of placing sheets than the model LA and the model LB which are the laser type recording devices 13. Similarly, even in the ink-jet type recording devices 13, the upper limit of the number of placing sheets of the model IJA is less than that of the model IJB. Similarly, in the laser type recording devices 13, the upper limit of the number of placing sheets is the same between the model LA and the model LB. In this way, the post-processing controller 76 can determine the upper limit of the number of placing sheets corresponding to the recording type of the recording device 13 and the model of the recording device 13.

The setting information may include information that can determine a paddle rotation table. The paddle rotation table is a table for controlling an amount of rotation of the paddle 67. Specifically, the model IJA corresponds to a paddle rotation table PT1. The model IJB corresponds to a paddle rotation table PT2. The model LA corresponds to a paddle rotation table PT3. The model LB corresponds to the paddle rotation table PT3.

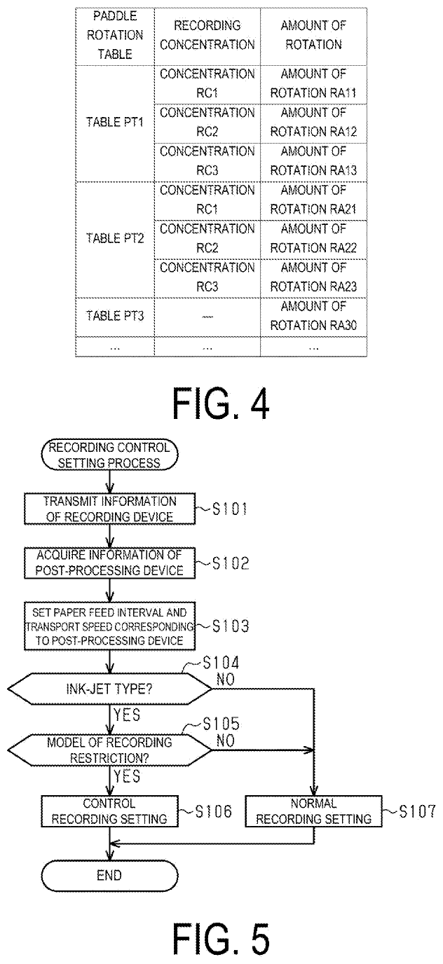

As illustrated in FIG. 4, the post-processing controller 76 stores the paddle rotation tables PT1 to PT3 in the memory. The paddle rotation tables PT1 to PT3 are tables stored in such a manner that the amount of rotation of the paddle 67 corresponds to a recording density on the medium 12 on which recording was performed. The paddle rotation table PT1 and PT2 are tables that change the amount of rotation of the paddle 67 according to the recording density. The paddle rotation table PT3 is a table in which the rotation amount of the paddle 67 is constant regardless of the recording density.

In the paddle rotation table PT1, when the recording density is within a recording density range RC1, an amount of rotation RA11 corresponds to the amount of rotation of the paddle 67. In the paddle rotation table PT1, when the recording density is within a recording density range RC2, an amount of rotation RA12 corresponds to the amount of rotation of the paddle 67. In the paddle rotation table PT1, when the recording density is within a recording density range RC3, an amount of rotation RA13 corresponds to the amount of rotation of the paddle 67. In the paddle rotation table PT2, when the recording density is within the recording density range RC1, an amount of rotation RA21 corresponds to the amount of rotation of the paddle 67. In the paddle rotation table PT2, when the recording density is within the recording density range RC2. an amount of rotation RA22 corresponds to the amount of rotation of the paddle 67. In the paddle rotation table PT2, when the recording density is within a recording density range RC3, an amount of rotation RA23 corresponds to the amount of rotation of the paddle 67. In the paddle rotation table PT3, regardless of the recording density, an amount of rotation RA30 corresponds to the amount of rotation of the paddle 67.

The recording density in the recording density range RC1 is lower than that in the recording density range RC2. The recording density in the recording density range RC2 is lower than that in the recording density range RC3. The amount of rotation of RA30 is smaller than any of the amounts of rotation RA11 to RA13 and RA21 to RA23. The amount of rotation of RA21 is smaller than the amount of rotation of RA11. The amount of rotation of RA22 is smaller than the amount of rotation of RA12. The amount of rotation of RA23 is smaller than the amount of rotation of RA13. The amount of rotation of RA11 is smaller than the amount of rotation of RA12. The amount of rotation of RA12 is smaller than the amount of rotation of RA13. The amount of rotation of RA21 is smaller than the amount of rotation of RA22. The amount of rotation of RA22 is smaller than the amount of rotation of RA23. Thus, the model IJA and the model IJB which are the ink-jet type recording devices 13 have a larger amount of rotation of the paddle 67 than the model LA and the model LB which are the laser type recording devices 13. Similarly, even in the ink-jet type recording devices 13, when the recording density is within the same range, the model IJA has a larger amount of rotation of the paddle 67 than the model IJB. In the model IJA, when the recording density is within a large range, the amount of rotation of the paddle 67 is larger than in a case in which the recording density is within a small range. In the model IJB, as in the model IJA, when the recording density is within a large range, the amount of rotation of the paddle 67 is larger than in the case in which the recording density is within a small range. Similarly, in the laser type recording devices 13, the amount of rotation of the paddle 67 is the same between the model LA and the model LB. In this way, the post-processing controller 76 can determine the amount of rotation of the paddle 67 corresponding to the recording type of the recording device 13, the model of the recording device 13, and the recording density.

In the present embodiment, whether or not the medium 12 is valid or invalid, the reception interval, the transport path, the post-processing interval, and the type of the paddle rotation table are associated with each other to have a suitable relationship. Specifically, when the recording type of the recording device 13 is the ink-jet type, the transport distance of the medium 12 in the post-processing device 14 is longer that than in a case in which the recording type is the laser type, and the medium 12 waits. Thus, when the recording type of the recording device 13 is the ink-jet type, the reception interval becomes longer and the post-processing interval is also longer than in the case in which the recording type is the laser type. Further, when the recording type of the recording device 13 is the ink-jet type, the amount of rotation of the paddle 67 is larger, the time for matching the medium 12 is longer, and the post-processing interval is also longer than in the case in which recording type is the laser type.

Recording Control Setting Process

Here, referring to FIG. 5, a recording control setting process will be described. The recording control setting process is a process performed by the recording controller 35 of the recording device 13 when power of the recording device 13 is turned on.

As illustrated in FIG. 5, in Step S101, the recording controller 35 transmits information of the recording device 13 to the post-processing device 14. The information of the recording device 13 is stored in the memory of the recording controller 35. The information of the recording device 13 includes information that can determine the recording type of the recording device 13. Specifically, the information of the recording device 13 includes first information capable of determining that the recording type of the recording device 13 is the ink-jet type. The information of the recording device 13 includes second information capable of determining that the recording type of the recording device 13 is the laser type. The information of the recording device 13 includes model information that can determine a model of the post-processing device 14. When Step S101 is ended, the recording controller 35 proceeds to Step S102.

In Step S102, the recording controller 35 acquires information of the post-processing device 14 due to communication with the post-processing device 14. The information of the post-processing device 14 includes model information that can determine the model of the post-processing device 14. Thus, the recording controller 35 can determine the model of the post-processing device 14.

The information of the post-processing device 14 includes information that can determine the reception interval for receiving the medium 12 in the reception part 50 of the post-processing device 14. Thus, the recording controller 35 can determine the reception interval of the post-processing device 14.

The information of the post-processing device 14 may include recording restriction information that can determine the restriction of the recording in the restriction region on the medium 12. The restriction region on the medium 12 includes a punching region on the medium 12. The punching region on the medium 12 is a region in which the punching process is performed by the post-processing device 14. In other words, the information of the post-processing device 14 may include at least information that can determine the restriction of the recording in the punching region on the medium 12. When Step S102 is ended, the recording controller 35 proceeds to Step S103.

In Step S103, the recording controller 35 sets a paper feed interval and a transport speed corresponding to the post-processing device 14. In this process, the recording controller 35 determines the paper feed interval suitable for the reception interval of the post-processing device 14 based on the information that can determine the reception interval of the post-processing device 14. The paper feed interval is an interval at which the medium 12 is fed by the paper feed mechanism 21. The recording controller 35 sets the paper feed interval suitable for the reception interval of the post-processing device 14. In particular, in the recording controller 35, when the recording type is the ink-jet type, the reception interval of the post-processing device 14 becomes longer and the paper feed interval is also longer than in the case in which the recording type is the laser type. That is, when the recording type of the recording device 13 is the ink-jet type, the recording controller 35 performs control of further increasing the paper feed interval of the medium 12 by the paper feed mechanism 21 than in the case in which the recording device 13 is the laser type.

The recording controller 35 determines a transport speed suitable for the reception interval of the post-processing device 14 based on the information that can determine the reception interval of the post-processing device 14. The transport speed is a speed at which the medium 12 is transported by the first transport mechanism 24. The recording controller 35 sets a transport speed suitable for the reception interval of the post-processing device 14. In particular, in the recording controller 35, when the recording type is the ink-jet type, the reception interval of the post-processing device 14 becomes longer than in the case in which the recording type is the laser type, and the transport speed is also reduced. That is, when the recording type of the recording device 13 is the ink-jet type, the recording controller 35 performs the control of reducing the transport speed of the medium 12 by the first transport mechanism 24 than in the case in which the recording device 13 is the laser type. When Step S103 is ended, the recording controller 35 proceeds to Step S104.

Thus, the recording controller 35 can control the paper feed mechanism 21 with a set paper feed interval when the recording command is input. Further, when the recording command is input, the recording controller 35 can control the first transport mechanism 24 to transport the medium 12 at the set transport speed.

The recording controller 35 may transmit, to the intermediate device 15, the information that can determine the transport speed of the medium 12. Thus, the intermediate device 15 can determine the transport speed of the medium 12 in the recording device 13. The intermediate device 15 may determine the transport speed of the medium 12 in the intermediate device 15 based on the transport speed of the medium 12 in the recording device 13.

In Step S104, the recording controller 35 determines whether or not the recording type is the ink-jet type. The information that can determine the recording type is stored in the memory of the recording controller 35. When the recording controller 35 determines that the recording type is the ink-jet type, the process proceeds to Step S105. When the recording controller 35 determines that the recording type is not the ink-jet type, the recording controller 35 proceeds to Step S106. In other words, when the recording controller 35 determines that the recording type is the laser type, the process proceeds to Step S106.

In Step S105, the recording controller 35 determines whether or not the medium 12 is a subject, in which the recording in the punching region is restricted, based on the recording restriction information. When the recording controller 35 determines that the medium 12 is the subject in which the recording in the punching region is restricted, the recording controller 35 proceeds to Step S106. When the recording controller 35 determines that the medium 12 is not the subject in which the recording in the punching region is restricted, the recording controller 35 proceeds to Step S107.

In Step S106, the recording controller 35 sets restricted recording information that restricts the recording on the medium 12. When Step S106 is ended, the recording controller 35 ends a recording control setting process. Thus, the recording controller 35 controls the recording part 27 to restrict the recording in the restriction region 12D of the medium 12 based on the restricted recording information when the recording command involving the punching process is input. In other words, the recording controller 35 restricts the recording in the restriction region 12D of the medium 12 when the recording type of the recording device 13 is the ink-jet type.

In Step S107, the recording controller 35 sets normal recording information that does not restricts the recording on the medium 12. When Step S107 is ended, the recording controller 35 ends the recording control setting process. Thus, the recording controller 35 controls the recording part 27 not to restrict the recording in the restriction region 12D of the medium 12 based on the normal recording information even when the recording command involving the punching process is input.

Restriction of Recording

Here, the restriction of the recording on the medium 12 will be described.

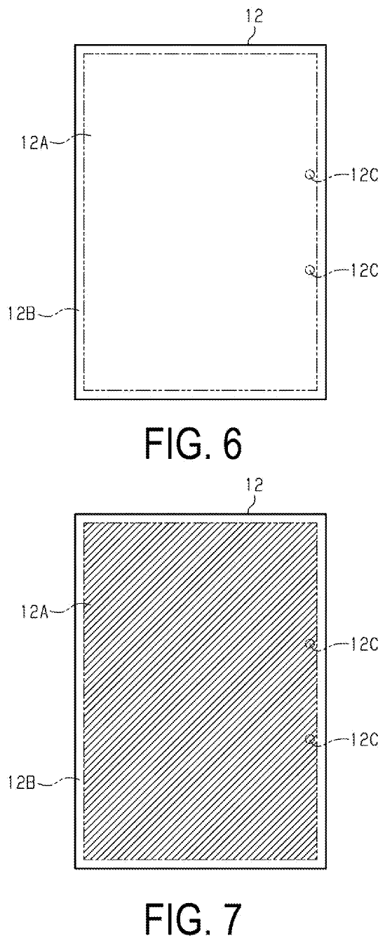

As illustrated in FIG. 6, the medium 12 includes a recordable region 12A. The recordable region 12A is a rectangular region excluding a peripheral region 12B of the medium 12. The recordable region 12A corresponds to a region that can be recorded by the recording part 27. The recordable region 12A includes a punching region 12C. The punching region 12C corresponds to a region that is punched by the punching process of the post-processing device 14. In the present embodiment, the recordable region 12A has two punching regions 12C, but may have one or three or more punching regions. The punching regions 12C are located at positions along a long side of the medium 12, but may be at positions along a short side of the medium 12.

As illustrated in FIG. 7, when the restriction of the recording is not performed, the recording is performed in the recordable region 12A. In this case, the recording is also performed in the punching region 12C.

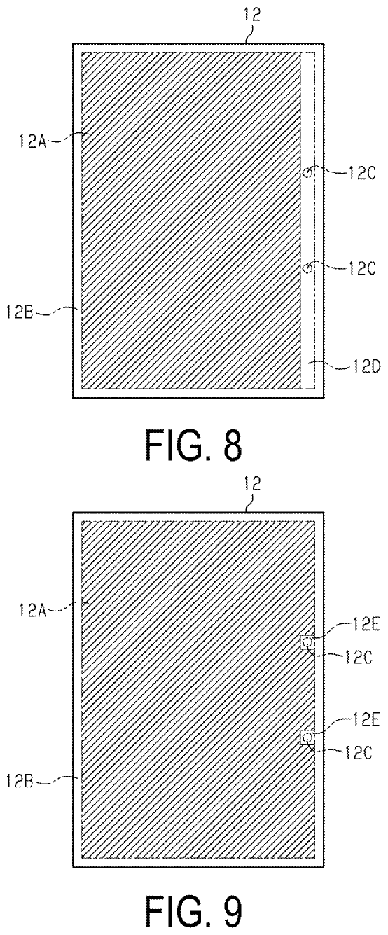

As illustrated in FIG. 8, when the restriction of the recording is performed, the recording may be performed in a region excluding the restriction region 12D in the recordable region 12A. The restriction region 12D is a region including at least the punching region 12C. In this case, the recording is not performed in the restriction region 12D. That is, the recording is also not performed in the punching region 12C. The restriction region 12D may be an edge region on the recordable region 12A located at a position near the punching region 12C. In this case, an image corresponding to the restriction region 12D is not recorded on the medium 12.

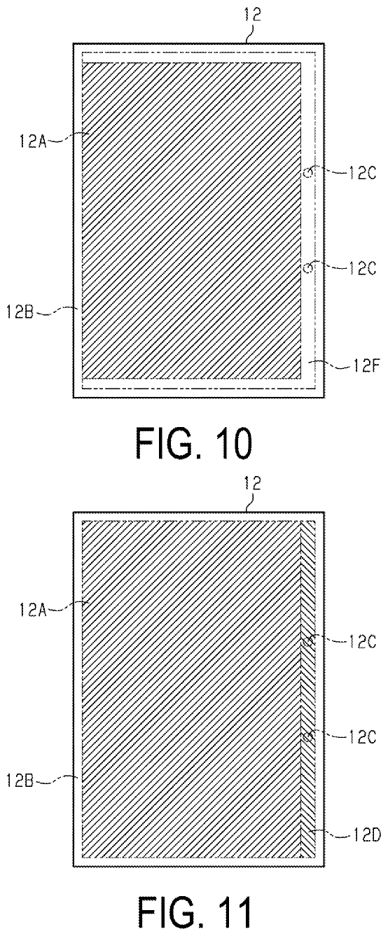

As illustrated in FIG. 9, a restriction region 12E may be a peripheral edge region in the punching region 12C. In this case also, the image corresponding to the restriction region 12E is not recorded on the medium 12.

As illustrated in FIG. 10, an image reduced by the same aspect ratio is recorded in the recordable region 12A while the image is not recorded in a restriction region 12F except the region in which the image is recorded. The restriction region 12F includes the punching region 12C. The recording controller 35 controls the recording part 27 to reduce the image and to perform the recording on the medium 12. Thus, the reduced image is recorded on the medium 12.

As shown in FIG. 11, an image having a low recording density may be recorded in the restriction region 12D. In this case, the image having the lower recording density is recorded in the punching region 12C. The recording controller 35 controls the recording part 27 so that an image corresponding to the restriction region 12D is recorded on the medium 12 in a state in which a recording density of the image is reduced. Thus, the image having the low recording density is recorded in the restriction region 12D. Similarly, an image having a low recording density may also be recorded in the restriction regions 12E and 12F. In this way, the recording in at least the punching region 12C in the recordable region 12A of the medium 12 is restricted.

Post-Processing Control Setting Process

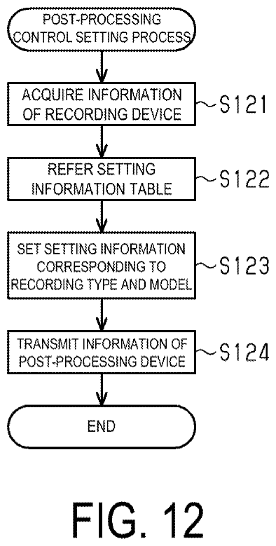

Next, a post-processing control setting process will be described with reference to FIG. 12. The post-processing control setting process is a process performed by the post-processing controller 76 of the post-processing device 14 when power of the post-processing device 14 is turned on.

As illustrated in FIG. 12, in Step S121, the post-processing controller 76 acquires information of the recording device 13 due to communication with the recording device 13. The information of the recording device 13 includes recording type information that can determine the recording type of the recording device 13. The recording type of the recording device 13 includes the ink-jet type and the laser type. That is, the information of the recording device 13 includes first information capable of determining that the recording type of the recording device 13 is the ink-jet type. The information of the recording device 13 includes second information capable of determining that the recording type of the recording device 13 is the laser type. In this way, the post-processing controller 76 can acquire any one of the first information and the second information as the information of the recording device 13 when power of the post-processing device 14 is turned on.

The information of the recording device 13 includes model information that can determine the model of the recording device 13. In this way, the post-processing controller 76 can acquire the model information of the recording device 13 as the information of the recording device 13 when power of the post-processing device 14 is turned on. The post-processing controller 76 that performs such a process corresponds to an example of an acquisition part. When Step S121 is ended, the post-processing controller 76 proceeds to Step S122.

In Step S122, the post-processing controller 76 refers to the setting information table ST. When Step S122 is ended, the post-processing controller 76 proceeds to Step S123.

In Step S123, the post-processing controller 76 reads, from the setting information table ST, setting information corresponding to the recording type and the model based on the information of the recording device 13. The post-processing controller 76 stores the setting information corresponding to the recording type and the model in the memory. Thus, the post-processing controller 76 can set the setting information corresponding to the recording type and the model. When Step S123 is ended, the post-processing controller 76 proceeds to Step S124.

In this way, the post-processing controller 76 performs various controls based on the setting information when the recording command involving the post-processing is input. Specifically, the post-processing controller 76 controls the second transport mechanism 55 so that the medium 12 before the post-processing is performed is transported to the first transport path 52 when the recording type of the recording device 13 is the ink-jet type. The post-processing controller 76 controls the second transport mechanism 55 so that the medium 12 before the post-processing is performed is transported to the second transport path 53 when the recording type of the recording device 13 is the laser type.

The post-processing controller 76 controls the second transport mechanism 55 so that the medium 12 before the post-processing is performed waits for a predetermined time in the transport path 16 in the post-processing device 14 when the recording type of the recording device 13 is the ink-jet type. The post-processing controller 76 controls the second transport mechanism 55 so that the medium 12 before the post-processing is performed does not wait in the transport path 16 in the post-processing device 14 when the recording type of the recording device 13 is the laser type.

When the recording type of the recording device 13 is the ink-jet type, the post-processing controller 76 increases the post-processing interval more than in the case in which the recording type of the recording device 13 is the laser type.

The post-processing controller 76 dries the medium 12 transported to the post-processing part 68 by the drying mechanism 58 when the recording type of the recording device 13 is the ink-jet type. The post-processing controller 76 does not dry the medium 12 transported to the post-processing part 68 by the drying mechanism 58 when the recording type of the recording device 13 is the laser type.

The post-processing controller 76 causes the air blowing part 69 to blow air when the recording type of the recording device 13 is the ink-jet type. The post-processing controller 76 does not cause the air blowing part 69 to blow air when the recording type of the recording device 13 is the laser type.

In Step S124, the post-processing controller 76 transmits information of the post-processing device 14 to the recording device 13. The information of the post-processing device 14 includes the model information of the post-processing device 14. In this way, the post-processing controller 76 can transmit, to the recording device 13, information that can determine the model of the post-processing device 14.

The information of the post-processing device 14 includes information that can determine the reception interval corresponding to the recording type and the model. In this way, when the recording type of the recording device 13 is an ink-jet type, the post-processing controller 76 can transmit, to the recording device 13, information that can determine a longer reception interval than in the case in which the recording device 13 is the laser type. The post-processing controller 76 can transmit information that can determine the reception interval corresponding to the model of the recording device 13.

The information of the post-processing device 14 includes recording restriction information that can determine the restriction of the recording in the restriction region 12D of the medium 12. In this way, the post-processing controller 76 can transmit, to the recording device 13, information that can determine the restriction of the recording in the restriction region 12D of the medium 12 when the recording type of the recording device 13 is the ink-jet type. When Step S124 is ended, the post-processing controller 76 ends the post-processing control setting process.

Matching Control Process

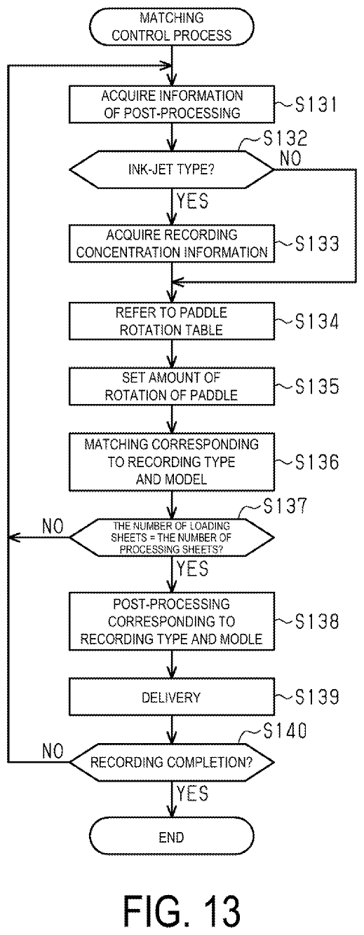

Next, a matching control process will be described with reference to FIG. 13. The matching control process is a process performed by the post-processing controller 76 of the post-processing device 14 when the recording command involving the post-processing is input.

As illustrated in FIG. 13, in Step S131, the post-processing controller 76 acquires post-processing information. The post-processing information includes the number of loading sheets that are loaded into the processing tray 61. Further, the post-processing information includes the number of processing sheets, on which the post-processing is performed, by communication with the recording device 13. When Step S131 is ended, the post-processing controller 76 proceeds to Step S132.

In Step S132, the post-processing controller 76 determines whether or not the recording type of the recording device 13 is the ink-jet type. When it is determined that the recording type of the recording device 13 is not the ink-jet type, the post-processing controller 76 does not perform Step S133 and proceeds to Step S134. When it is determined that the recording type of the recording device 13 is the ink-jet type, the post-processing controller 76 proceeds to Step S133.

In Step S133, the post-processing controller 76 acquires the recording density information by communication with the recording device 13. When Step S133 is ended, the post-processing controller 76 proceeds to Step S134.

As described above, when the recording type of the recording device 13 is the ink-jet type, the post-processing controller 76 can acquire the recording density information that can determine the recording density on the medium 12 by the recording device 13 as the information of the recording device 13. The post-processing controller 76 does not acquire the recording density information when the recording type of the recording device 13 is the laser type.

In Step S134, the post-processing controller 76 refers to a paddle rotation table corresponding to the recording type and the model of the recording device 13. When Step S134 is ended, the post-processing controller 76 proceeds to Step S135.

In Step S135, the post-processing controller 76 sets an amount of rotation of the paddle 67. When the recording type of the recording device 13 is the laser type, the post-processing controller 76 determines the amount of rotation from the referred paddle rotation table PT3 regardless of the recording density information. When the recording type of the recording device 13 is the ink-jet type, the post-processing controller 76 determines the amount of rotation corresponding to the recording density information from the referred paddle rotation table. When Step S135 is ended, the post-processing controller 76 proceeds to Step S136.

In Step S136, the post-processing controller 76 matches the medium 12 to correspond to the recording type and the model of the recording device 13 by rotating the paddle 67 with the set rotation amount. When Step S136 is ended, the post-processing controller 76 proceeds to Step S137.

In this way, the post-processing controller 76 rotates the paddle 67 based on the recording type of the recording device 13 and the model of the recording device 13. In particular, when the recording type of the recording device 13 is the ink-jet type, the post-processing controller 76 increases the amount of rotation of the paddle 67 as compared with the case in which the recording type of the recording device 13 is the laser type. The post-processing controller 76 rotates the paddle 67 based on the recording density information when the recording type of the recording device 13 is the ink-jet type.

In Step S137, the post-processing controller 76 determines whether or not the number of loading sheets of the medium 12 loaded on the processing tray 61 has reached the number of processing sheets. The post-processing controller 76 can determine the number of loading sheets of the medium 12 loaded on the processing tray 61 based on a detection result of the sensor 60. When it is determined that the number of loading sheets does not reach the number of processing sheets, the post-processing controller 76 proceeds to Step S131. When it is determined that the number of loading sheets reach the number of processing sheets, the post-processing controller 76 proceeds to Step S138.

In Step S138, the post-processing controller 76 causes the post-processing part 68 to perform the post-processing corresponding to the recording type and the model of the recording device 13 based on the setting information. In particular, when the punching process is performed as the post-processing, the post-processing controller 76 causes the post-processing part 68 to perform the punching process with the punching speed and the number of punching times corresponding to the recording type of the recording device 13 and the model of the recording device 13. In this case, when the recording device 13 is the ink-jet type, the post-processing controller 76 performs control of increasing the punching speed of the punching process and control of increasing the number of punching times in the punching process as compared with the case in which the recording device 13 is the laser type.

When the binding process is performed as the post-processing, the post-processing controller 76 causes the post-processing part 68 to perform the binding process with the upper limit of the number of binding sheets corresponding to the recording type of the recording device 13 and the model of the recording device 13. In this case, when the recording device 13 is the ink-jet type, the post-processing controller 76 reduces the upper limit of the number of binding sheets of the medium 12 that can be bound by the binding process as compared with the case in which the recording device 13 is the laser type. When Step S138 is ended, the post-processing controller 76 proceeds to Step S139.

In Step S139, the post-processing controller 76 transmits a plurality of media 12 that have been post-processed from the processing tray 61 to the support member 74 and places the plurality of medial2 that have been post-processed on the discharge stacker 75. The post-processing controller 76 transmits the medium 12 with the upper limit of the number of placing sheets corresponding to the recording type of the recording device 13 and the model of the recording device 13 as an upper limit. In this case, when the recording device 13 is the ink-jet type, the post-processing controller 76 reduces the upper limit of the number of placing sheets as compared with the case in which the recording device 13 is the laser type. When Step S139 is ended, the post-processing controller 76 proceeds to Step S140.

In the present embodiment, the post-processing controller 76 may stop the post-processing and may perform an error notification when a command for binding the number of processing sheets more than the upper limit of the number of the binding sheets is input. The post-processing controller 76 may stop the post-processing and may discharge the medium 12 loaded on the processing tray 61 when the command for binding the number of processing sheets more than the upper limit of the number of the binding sheets is input. In the present embodiment, the post-processing controller 76 may stop the transport and may perform an error notification when a command for binding the number of processing sheets more than the upper limit of the number of the placing sheets is input.

In Step S140, the post-processing controller 76 determines whether or not the recording has been ended. The post-processing controller 76 determines that the recording has ended when all the medial2 on which recording was performed are transported to the support member 74. When it is determined that the recording has not ended, the post-processing controller 76 proceeds to Step S131. When it is determined that the recording has ended, the post-processing controller 76 ends the matching control process.

In this way, the post-processing controller 76 performs the control of at least the post-processing based on whether the first information capable of determining that the recording type of the recording device 13 is the ink-jet type or the second information capable of determining that the recording type of the recording device 13 is the laser type is acquired. The post-processing controller 76 performs the control of the post-processing based on the model information of the recording device 13.

Action

Next, actions of the present embodiment will be described.

When the recording type of the recording device 13 is the ink-jet type, the medium 12 after recording includes a large amount of moisture as compared with the case in which the recording type of the recording device 13 is the laser type. Thus, when the recording type of the recording device 13 is the ink-jet type, the medium 12 after recording is swollen as compared with the case in which the recording type of the recording device 13 is the laser type. In the related art, it may not be possible to appropriately perform post-processing according to the recording type of the recording device 13.

Thus, in the recording system 11 of the present embodiment, the post-processing device 14 sets setting information corresponding to the recording type and the model of the recording device 13. Thus, the post-processing device 14 can appropriately perform control of the post-processing according to the recording type and the model of the recording device 13.

The recording device 13 sets the paper feed interval and the transport speed corresponding to the reception interval of the medium 12 in the post-processing device 14. The recording device 13 can make the restriction of the recording on the medium 12 valid when the recording type is the ink-jet type. Thus, the recording system 11 can appropriately perform the control of the post-processing corresponding to the recording type and the model of the recording device 13.

Specifically, when the recording type of the recording device 13 is the ink-jet type, the medium 12 after recording is swollen and a thickness of the medium 12 after recording increases as compared with the case in which the recording type of the recording device 13 is the laser type. Thus, the ink-jet type recording device 13 has the smaller number of sheets of medium 12 that can be bound than that in the laser type recording device 13. In the related art, the upper limit of the number of the binding sheets of the medium 12 capable of binding is constant. Thus, when the upper limit of the number of binding sheets of the medium 12 is adjusted to an appropriate upper limit of the number of binding sheets when recording is performed by the laser type recording device 13, the upper limit of the number of binding sheets when recording is performed by the ink-jet type recording device 13 increases. As a result, it may not be possible to appropriately bind the medium 12.

Thus, when the recording type of the recording device 13 to be connected is the ink-jet type, the post-processing device 14 according to the present embodiment can reduce the upper limit of the number of binding sheets of the medium 12 that can be bound as compared with the case in which the recording type is the laser type. Therefore, it is possible to appropriately perform the binding process according to the recording type of the recording device 13.

The ink-jet type recording device 13 is less likely to punch the medium 12 after recording as compared with the laser type recording device 13. In the related art, the punching speed of the punching process and the number of punching times of the punching process are constant. Therefore, when the punching speed of the punching process and the number of punching times of the punching process in the post-processing device 14 are adjusted to appropriate conditions when recording is performed by the laser type recording device 13, it is difficult to perform the punching when recording is performed by the ink-jet type recording device 13. As a result, it may not be possible to appropriately punch the medium 12. On the other hand, when the punching speed of the punching process and the number of punching times of the punching process are adjusted to the suitable conditions when the recording is performed by the ink-jet type recording device 13, the punching is easily performed when recording is performed by the laser type recording device 13, and the efficiency of the post-processing is reduced.

Thus, when the recording type of the recording device 13 to be connected is the ink-jet type, the post-processing device 14 according to the present embodiment can perform control of increasing the punching speed of the punching process and control of increasing the number of punching times in the punching process as compared with the case in which the recording type is the laser type. Therefore, the punching process can be appropriately performed corresponding to the recording type of the recording device 13.

When the recording type of the recording device 13 is the ink-jet type, the medium 12 after recording is swollen and a weight of the medium 12 after recording is increased as compared with the case in which the recording type of the recording device 13 is the laser type. In the related art, the upper limit of the number of placing sheets of the medium 12 that can be placed on the pair of support members 74 and the discharge stacker 75 is constant. Thus, when the upper limit of the number of placing sheets of the medium 12 is adjusted to an appropriate upper limit of the number of placing sheets when recording is performed by the ink-jet type recording device 13, the upper limit of the number of placing sheets when recording is performed by the laser type recording device 13 is reduced more than necessary. On the other hand, when the upper limit of the number of placing sheets of the medium 12 is adjusted to an appropriate upper limit of the number of placing sheets when recording is performed by the laser type recording device 13, the upper limit of the number of placing sheets when recording is performed by the ink-jet type recording device 13 is increased. Thus, a load more than necessary is applied to the pair of support members 74 and the discharge stacker 75 on which the medium 12 is placed.

Thus, when the recording type of the recording device 13 to be connected is the ink-jet type, the post-processing device 14 according to the present embodiment can reduce the upper limit of the number of placing sheets of the medium 12 as compared to the case in which the recording type is the laser type. Thus, the medium 12 can be appropriately placed on the pair of support members 74 and the discharge stacker 75 according on the recording type of the recording device 13.

When the recording type of the recording device 13 is the ink-jet type, the medium 12 after recording is swollen as compared with the case in which the recording type of the recording device 13 is the laser type, and a friction force according to the transport of the medium 12 after recording that is loaded on the processing tray 61 increases. In addition, when the recording type of the recording device 13 is the ink-jet type, the medium 12 after recording is swellen, and the medium 12 after recording that is loaded on the processing tray 61 is easily curled as compared with the case in which the recording type of the recording device 13 is the laser type.

Therefore, in the ink-jet type recording device 13, it is more difficult to transport the medium 12 after recording that is loaded on the processing tray 61 with the paddle 67 than in the laser type recording device 13. In such a case, the time to match the medium 12 after recording increases, and an interval during which the post-processing is performed becomes longer. In addition, for example, there is also a possibility that the matching of the medium 12 deteriorates, and when the curled state of the medium 12 after recording that is loaded on the processing tray 61 continues, it may collide with the next transported medium 12, which causes a paper jam. In the related art, when the amount of rotation of the paddle 67 is adjusted to an appropriate amount of rotation when recording is performed by the ink-jet type recording device 13, an amount of transport of the medium 12 on which recording was performed by the laser type recording device 13 increases, and buckling and the like of the medium 12 may occur. When the amount of rotation of the paddle 67 is adjusted to an appropriate amount of rotation when recording is performed by the laser type recording device 13, the amount of transport of the medium 12 on which recording was performed by the ink-jet type recording device 13 may be reduced, and the medium 12 may not be properly transported.

In addition, the ink-jet type recording device 13 needs to ensure more time to dry the medium 12 after recording than the laser type recording device 13, and the interval during which the post-processing is performed is longer. In the related art, when the interval during which the post-processing is performed is adjusted to an appropriate interval when recording is performed by the ink-jet type recording device 13, the interval during which the post-processing is performed when the recording is performed by the laser type recording device 13 increases, and the efficiency of the post-processing is reduced. When the interval during which the post-processing is performed is set to a suitable interval when recording is performed by the laser type recording device 13, the interval during which the post-processing is performed when recording is performed by the ink-jet type recording device 13 is reduced, and the post-processing may not be able to be appropriately performed.

Thus, when the recording type of the recording device 13 to be connected is the ink-jet type, the post-processing device 14 of the present embodiment can increase the amount of rotation of the paddle 67 configured to transport the medium 12 loaded on the processing tray 61 as compared with the case in which the recording type is the laser type. Therefore, according to the recording type of the recording device 13, the medium 12 loaded on the processing tray 61 can be appropriately transported.

In addition, when the recording type of the recording device 13 to be connected is the ink-jet type, the post-processing device 14 of the present embodiment can transport the medium 12 before the post-processing is performed to the first transport path 52 having a longer path length as compared with the case in which the recording type is the laser type. Thus, due to the path length for transporting the medium 12 being adjusted according to the recording type of the recording device 13 before the post-processing is performed, it is possible to adjust the time to dry the medium 12 before the post-processing, and the post-processing can be performed appropriately.

Further, when the recording type of the recording device 13 to be connected is the ink-jet type, the post-processing device 14 of the present embodiment can cause the medium 12 before the post-processing is performed to wait in the transport path 16 of the post-processing device 14. Therefore, the time for drying the medium 12 before the post-processing is performed can be adjusted according to the recording type of the recording device 13, and the post-processing can be appropriately performed.

Further, when the recording type of the recording device 13 to be connected is the ink-jet type, the post-processing device 14 of the present embodiment can increase the post-processing interval as compared with the case in which the recording type of the recording device 13 to be connected is the laser type. Therefore, the post-processing interval can be adjusted according to the recording type of the recording device 13, and the post-processing can be appropriately performed.

Further, the recording device 13 of the present embodiment can feed the medium 12 at a paper feed interval corresponding to the reception interval of the medium 12 in the post-processing device 14. The recording device 13 of the present embodiment can transport the medium 12 at a transport speed corresponding to the reception interval of the medium 12 in the post-processing device 14.

Furthermore, when the recording type of the recording device 13 to be connected is the ink-jet type, the post-processing device 14 of the present embodiment can dry the medium 12 transported to the post-processing part 68 with the drying mechanism 58. Therefore, moisture contained in the medium 12 transported to the post-processing part 68 can be adjusted according to the recording type of the recording device 13, and the post-processing can be performed appropriately.

In addition, when the recording type of the recording device 13 to be connected is the ink-jet type, the post-processing device 14 of the present embodiment can cause the air blowing part 69 to blow air toward the medium 12. Therefore, it is possible to change whether or not the air blowing part 69 blows air according to the recording type of the recording device 13. Therefore, it is possible to suppress curling of the medium 12 after recording that is loaded on the processing tray 61, and the post-processing can be performed appropriately.

Effect

Effects of the present embodiment will now be described.

(1) When the recording device 13 is replaced with another recording device of a different recording type in the ink-jet type and the laser type, control of at least the post-processing can be performed based on information that can determine the recording type after replacement. Therefore, when the recording device 13 is replaced with another recording device of a different recording type in the ink-jet type and the laser type, the post-processing can be appropriately performed without replacing the post-processing device 14. Therefore, a manufacturer can easily manufacture and manage the post-processing device 14 without imposing a work burden and a cost burden on a user.

(2) When the recording type of the recording device 13 connected to the post-processing device 14 is the ink-jet type, the upper limit of the number of binding sheets of the medium 12 that can be bound can be reduced as compared with the case in which the recording type is the laser type. Therefore, when the recording device 13 is replaced with another recording device of a different recording type in the ink-jet type and the laser type, the binding process can be performed appropriately according to the recording type of the recording device 13 after the replacement without replacing the post-processing device 14.

(3) When the recording type of the recording device 13 connected to the post-processing device 14 is the ink-jet type, the upper limit of the number of placing sheets of the medium 12 that can be placed on the pair of support members 74 and the discharge stacker 75 can be reduced as compared with the case in which the recording type is the laser type. Therefore, when the recording device 13 is replaced with another recording device of a different recording type in the ink-jet type and the laser type, the medium 12 can be appropriately placed according to the recording type of the recording device 13 after the replacement without replacing the post-processing device 14.

(4) When the recording type of the recording device 13 connected to the post-processing device 14 is the ink-jet type, it is possible to increase the amount of rotation of the paddle 67 configured to transport the medium 12 loaded on the processing tray 61 as compared with the case in which the recording type is the laser type. Therefore, when the recording device 13 is replaced with another recording device of a different recording type in the ink-jet type and the laser type, the medium 12 loaded on the processing tray 61 can be appropriately transported according to the recording type of the recording device 13 after the replacement without replacing the post-processing device 14.

(5) When the recording type of the recording device 13 connected to the post-processing device 14 is the ink-jet type, information that can determine the reception interval that is longer than in the case in which the recording type is the laser type can be transmitted to the recording device 13. When the recording type of the recording device 13 connected to the post-processing device 14 is the ink-jet type, the post-processing interval can be longer than the case in which recording type is the laser type. Therefore, when the recording device 13 is replaced with another recording device of a different recording type in the ink-jet type and the laser type, the post-processing can be performed appropriately according to the recording type of the recording device 13 after the replacement without replacing the post-processing device 14. In addition, when the ink-jet type recording device 13 is replaced with the laser type recording device 13, the post-processing according to the laser type recording device 13 can be performed without replacing the post-processing device 14, and a decrease in the efficiency of the post-processing can be prevented.

(6) When the recording type of the recording device 13 connected to the post-processing device 14 is the ink-jet type, the medium 12 transported to the post-processing part 68 can be dried by the drying mechanism 58. Therefore, when the recording device 13 is replaced with another recording device of a different recording type in the ink-jet type and the laser type, the moisture contained in the medium 12 transported to the post-processing part 68 can be adjusted according to the recording type of the recording device 13 after the replacement without replacing the post-processing device 14. Therefore, the post-processing can be appropriately performed. Further, when the ink-jet type recording device 13 is replaced with the laser type recording device 13, the medium 12 transported to the post-processing part 68 is not dried by the drying mechanism 58 without replacing the post-processing device 14, and unnecessary energy is not consumed.

(7) When the recording type of the recording device 13 connected to the post-processing device 14 is the ink-jet type, it is possible to perform the control of increasing the punching speed of the punching process, and the control of increasing the number of punching times in the punching process as compared to the case in which the recording type is the laser type. Therefore, when the recording device 13 is replaced with another recording device of a different recording type in the ink-jet type and the laser type, the punching process can be appropriately performed according to the recording type of the recording device 13 after the replacement without replacing the post-processing device 14. In addition, when the ink-jet type recording device 13 is replaced with the laser type recording device 13, it is possible to perform the punching process according to the laser type recording device 13 without replacing the post-processing device 14, and thus, a decrease in the efficiency of the post-processing can be prevented.

(8) When the recording type of the recording device 13 connected to the post-processing device 14 is the ink-jet type, the air blowing part 69 can blow air to the medium 12. Thus, when the recording device 13 is replaced with another recording device of a different recording type in the ink-jet type and the laser type, it is possible to change whether or not the air blowing part 69 is caused to blow air according to the recording type of the recording device 13 after the replacement without replacing the post-processing device 14. Therefore, it is possible to suppress the curling of the medium 12 after recording that is loaded on the processing tray 61, and the post-processing can be performed appropriately.

(9) When the recording type of the recording device 13 connected to the post-processing device 14 is the ink-jet type, the medium 12 before the post-processing is performed can be transported to the first transport path 52 having a longer path length than the second transport path 53. When the recording type of the recording device 13 connected to the post-processing device 14 is the laser type, the medium 12 before the post-processing can be transported to the second transport path 53. Thus, when the recording device 13 is replaced with another recording device of a different recording type in the ink-jet type and the laser type, the path length for transporting the medium 12 before the post-processing is performed can be adjusted according to the recording type of the recording device 13 after the replacement without replacing the post-processing device 14. Therefore, the time to dry the medium 12 before the post-processing is performed can be adjusted, and the post-processing can be performed appropriately. Also, when the ink-jet type recording device 13 is replaced with the laser type recording device 13, it is possible to transport the medium 12 to the second transport path 53 according to the laser type recording device 13 without replacing the post-processing device 14, and the decrease in the efficiency of the post-processing can be prevented.

(10) When the recording type of the recording device 13 connected to the post-processing device 14 is the ink-jet type, the medium 12 before the post-processing is performed can wait in the transport path 16 in the post-processing device 14. When the recording type of the recording device 13 connected to the post-processing device 14 is the laser type, the medium 12 before the post-processing is performed does not wait in the transport path 16 in the post-processing device 14. Thus, when the recording device 13 is replaced with another recording device of a different recording type in the ink-jet type and the laser type, it is possible to adjust whether or not the medium 12 waits according to the recording type of the recording device 13 after the replacement without replacing the post-processing device 14. Therefore, the time to dry the medium 12 before the post-processing can be adjusted, and the post-processing can be performed appropriately. Further, when the ink-jet type recording device 13 is replaced with the laser type recording device 13, the medium does not wait in the transport path 16 in the post-processing device 14 according to the laser type recording device 13 without replacing the post-processing device 14, and the decrease in the efficiency of the post-processing can be prevented.

(11) When the power of the post-processing device 14 is turned on, it is possible to determine whether the recording type of the recording device 13 connected to the post-processing device 14 is the ink-jet type or the laser type. Thus, after the power of the post-processing device 14 is turned on, the post-processing can be performed appropriately according to the recording type of the recording device 13. Further, after the power of the post-processing device 14 is turned on, the processing time for performing control of the post-processing can be reduced as compared with a case in which the information that can determine the recording type of the recording device 13 is acquired for each post-processing.

(12) Model information that can determine the model of the recording device 13 in addition to whether the recording type of the recording device 13 connected to the post-processing device 14 is the ink-jet type or the laser type can be acquired. Thus, the control of at least the post-processing can be performed based on the model information. Therefore, when the recording device 13 is replaced with another recording device of a different model, the post-processing can be performed appropriately according to the model of the recording device 13 after the replacement without replacing the post-processing device 14.

(13) When the recording type of the recording device 13 connected to the post-processing device 14 is the ink-jet type, the control of at least the post-processing can be performed based on the recording density on the medium 12 that serves as an indicator of the control of the post-processing. Therefore, when the laser type recording device 13 is replaced with the ink-jet type recording device 13, the post-processing can be performed appropriately according to the recording density due to the ink-jet type recording device 13 without replacing the post-processing device 14. Further, when the recording type of the recording device 13 connected to the post-processing device 14 is the laser type, the control of at least the post-processing can be performed without acquiring the recording density on the medium 12 that does not serve as an indicator of the control of the post-processing. Therefore, when the ink-jet type recording device 13 is replaced with the laser type recording device 13, the processing time for performing the control of the post-processing can be reduced and the post-processing can be performed appropriately without replacing the post-processing device 14.

(14) When the recording type of the recording device 13 connected to the post-processing device 14 is the ink-jet type, information that can determine the restriction of the recording in at least the punching region 12C of the medium 12 can be transmitted to the recording device 13. Thus, when the recording type of the recording device 13 connected to the post-processing device 14 is the ink-jet type, the restriction of the recording in at least the punching region 12C of the medium 12 can be determined in the recording device 13. In this way, when the laser type recording device 13 is replaced with the ink-jet type recording device 13, the recording in the punching region 12C of the medium 12 can be restricted according to the ink-jet type recording device 13 without replacing the post-processing device 14. Therefore, the punching process can be appropriately performed.

Modified Examples

The present embodiment described above may be modified as follows. The present embodiment and modified examples thereof to be described below may be implemented in combination within a range in which a technical contradiction does not arise.

The post-processing device 14 may acquire one piece of information that can determine both the recording type of the recording device 13 and the model of the recording device 13. The post-processing device 14 may acquire information that can determine the recording type of the recording device 13 and information that can determine the model of the recording device 13 as separate pieces of information.

The post-processing device 14 may acquire the setting information table ST, the paddle rotation tables PT1 to PT3, and the like by communication with another device such as a terminal device and a server device.

The post-processing device 14 may acquire the setting information corresponding to the recording type of the recording device 13 from the recording device 13, in addition to the recording type of the recording device 13. In other words, the recording device 13 may transmit the setting information corresponding to the recording type of the recording device 13 to the post-processing device 14, in addition to the recording type of the recording device 13. The post-processing device 14 may acquire the setting information table ST and the paddle rotation tables PT1 to PT3, and the like corresponding to the recording type of the recording device 13 from the recording device 13. In other words, the recording device 13 may transmit the setting information table ST, the paddle rotation tables PT1 to PT3, and the like corresponding to the recording type of the recording device 13 to the post-processing device 14, in addition to the recording type of the recording device 13.

The post-processing device 14 may include an input part that can be input by a user. The input part may be, for example, a switch operable by a user, or may be an input device such as a touch panel. The post-processing device 14 may acquire the recording type of the recording device 13 and the model of the recording device 13 by an input from the input part.

The post-processing device 14 may acquire the information that can determine the recording type of the recording device 13 and the model of the recording device 13 when the recording command involving the post-processing is input. The post-processing device 14 may not acquire the information that can determine the recording type of the recording device 13 and the model of the recording device 13 when the power is turned on.

When the recording type of the recording device 13 is the laser type, at least some of the setting information of the post-processing may be different according to the model of the recording device 13.

The post-processing device 14 may vary a degree of drying by the drying mechanism 58 according to the model of the recording device 13 when the recording type of the recording device 13 is the ink-jet type.

The post-processing device 14 may include a plurality of paddles 67. The plurality of paddles 67 may have the same or different shapes. The post-processing device 14 may store the paddle rotation table corresponding to each of the plurality of paddles 67 in the memory.

The rotary transport part may not be the paddle 67 including the blade 67B, and may be a roller, for example. That is, the rotary transport part may be configured to transport the medium 12 loaded on the processing tray 61 by rotating in contact with the medium 12 that is loaded on the processing tray 61.

The placement part may not have the pair of support members 74 and may be the discharge stacker 75. That is, the placement part may be able to place the medium 12 after the post-processing is performed.

The post-processing device 14 may vary the transport speed for transporting the medium 12 in the transport path 16 in the post-processing device 14 based on the recording type of the recording device 13 and the model of the recording device 13. In this case, when the recording type of the recording device 13 is the ink-jet type, the post-processing device 14 may reduce the transport speed as compared with the case in which the recording type is the laser type.

The post-processing device 14 may not be branched into the first transport path 52 and the second transport path 53 as the transport path 16 in the post-processing device 14.

The post-processing device 14 may not cause the medium 12 to wait in the transport path 16 in the post-processing device 14.

The drying mechanism 58 may be provided at a position along the second introduction path 51. The drying mechanism 58 may be provided at a position along the joining path 54.

The post-processing device 14 may perform the control of the post-processing other than the rotational control of the paddle 67 based on the recording density on the medium 12.

The post-processing device 14 may perform the control of the post-processing based on at least any of a recording speed by the recording part 27, a temperature, a humidity, and a paper size. In this case, the post-processing device 14 acquires the recording speed and the paper size by communication with the recording device 13. The post-processing device 14 may acquire the temperature and humidity by communicating with the recording device 13, or may acquire the temperature and humidity by the post-processing device 14 itself.

The post-processing device 14 may cause the air blowing part 69 to blow air when the recording type is the laser type. Thus, the medium 12 after recording can be cooled. In this case, when the recording type of the recording device 13 is the ink-jet type, the post-processing device 14 may cause the air blowing part 69 to blow air at a larger airflow rate than in the case in which the recording type is the laser type. When the recording type of the recording device 13 is the ink-jet type, the post-processing device 14 may cause the air blowing part 69 to blow air at a smaller airflow rate as than in the case in which the recording type is the laser type. The air blowing part 69 may be provided separately when the recording type of the recording device 13 is the ink-jet type and when the recording type of the recording device 13 is the laser type.

When the recording type of the recording device 13 is the ink-jet type or the laser type, the post-processing device 14 may have the same punching speed or the same number of punching times of the punching process. In other words, when the recording type of the recording device 13 is the ink-jet type, the post-processing device 14 may perform at least one of control to increase the punching speed of the punching process and control to increase the number of punching times in the punching process as compared with the case in which the recording type is the laser type.

The post-processing device 14 may transmit, to the recording device 13, information that can determine at least any one of the paper feed interval of the recording device 13 and the transport speed of the recording device 13 instead of information that can determine the reception interval of the medium 12.

The post-processing device 14 may include the inversion processing part 40 of the intermediate device 15 in the first transport path 52. In particular, the post-processing device 14 may have the first switch back path 42 and the second switch back path 43 in the first transport path 52 and may alternately carry the medium 12. In this way, the path length of the first transport path 52 can be increased by providing the first switch back path 42 and the second switch back path 43. The first switch back path 42 and the second switch back path 43 may function as the waiting parts.

The post-processing controller 76 may be capable of communicating with the intermediate device 15. The post-processing controller 76 may transmit information that can determine the transport speed of the medium 12 to the intermediate device 15.

The post-processing device 14 and the intermediate device 15 may be combined as the post-processing device. In this case, the first transport path 52 and the second transport path 53 may be provided in the intermediate device 15. Further, for example, the inversion processing part 40 may be provided in the first transport path 52. The waiting part may be provided in the intermediate device 15. The drying mechanism 58 may be provided in the intermediate device 15.

The first transport path 52 and the second transport path 53 may be provided in the recording device 13. In this case, the recording controller 35 may switch the transport path based on information that can determine a recording format stored in the memory, or may switch the transport path by communication with the post-processing device 14.

The waiting part may be provided in the recording device 13. In this case, the recording controller 35 may cause the medium 12 to wait based on the information that can determine the recording format stored in the memory, or may cause the medium 12 to wait by communication with the post-processing device 14.

The drying mechanism 58 may be provided in the recording device 13. In this case, the recording controller 35 may control whether or not the medium 12 is dried in the drying mechanism 58 based on the information that can determine the recording format stored in the memory, or may control whether or not the medium 12 is dried in the drying mechanism 58 by the communication with the post-processing device 14.

When the recording type is the ink-jet type, the recording device 13 may perform at least one of the control of increasing the paper feed interval of the medium 12 by the paper feed mechanism 21, and the control of reducing the transport speed of the medium 12 by the first transport mechanism 24 as compared with the case in which the recording type is the laser type.

The post-processing device 14 and the intermediate device 15 may be integrally provided. In other words, the post-processing device 14 may include a function of the intermediate device 15.

The post-processing device 14 may include a controller when the recording type is the ink-jet type and a controller when the recording type is the laser type. The post-processing device 14 may perform the control of the post-processing by the controller corresponding to the recording type among the plurality of controllers. The plurality of controllers may be provided on the same substrate or may be provided on different substrates.

The medium 12 is not limited to paper and may be a film made of a synthetic resin, a cloth, a nonwoven fabric, a laminated medium, or the like.

Liquid can be arbitrarily selected as long as it can be recorded on the medium 12 by adhering to the medium 12. For example, an ink includes various compositions such as an aqueous ink, an oil-based ink, a gel ink, a hot melt ink, or the like, including particles of a functional material made of a solid such as pigments or metal particles dissolved, dispersed or mixed in a solvent.

The recording device 13 is not limited to a printer, and may be a printing apparatus. Further, the recording device 13 may be a composite having a scanner mechanism and a copy function in addition to the recording function.

### Supplementary Note

Hereinafter, technical concepts and effects thereof that are understood from the above-described embodiments and modified examples will be described.

(A) A reception part configured to receive a medium on which recording was performed by a recording device, a post-processing part configured to perform post-processing on the medium received by the reception part, and a controller configured to perform control of at least the post-processing are included, wherein the controller is configured to acquire, as information of the recording device, first information configured to determine that a recording type of the recording device is an ink-jet type, and second information configured to determine that the recording type of the recording device is a laser type, and the controller acquires the information of the recording device, performs the post-processing based on a first setting when the information of the recording device includes the first information configured to determine that the recording type is the ink-jet type, and performs the control of the post-processing based on a second setting different from the first setting when the information of the recording device includes the second information configured to determine that the recording type is the laser type.

According to this configuration, when the recording device is replaced with another recording device of a different recording type in the ink-jet type and the laser type, control of at least the post-processing can be performed based on information configured to determine the recording type after the replacement. Therefore, when the recording device is replaced with another recording device of a different recording type in the ink-jet type and the laser type, the post-processing can be performed appropriately without replacing the post-processing device. Therefore, a manufacturer can easily manufacture and manage the post-processing device without imposing a work burden and a cost burden on a user.

(B) The post-processing part may perform a binding process that binds a plurality of sheets of the medium as the post-processing, and when the first information is acquired, the controller may reduce an upper limit of the number of sheets of the medium to be bound by the binding process as compared with a case in which the second information is acquired.

According to this configuration, when the recording type of the recording device is the ink-jet type, it is possible to reduce the upper limit of the number of sheets of the medium configured to be bound as compared with the case in which the recording type is the laser type. Therefore, when the recording device is replaced with another recording device of a different recording type in the ink-jet type and the laser type, it is possible to appropriately perform the binding processing according to the recording type of the recording device after the replacement without replacing the post-processing device.

(C) A placement part on which the medium after the post-processing is placeable may be included, and when the first information is acquired, the controller may reduce the upper limit of the number of sheets of the medium placeable on the placement part as compared with the case in which the second information is acquired.

According to this configuration, when the recording type of the recording device is the ink-jet type, the upper limit of the number of sheets of the medium placeable on the placement part can be reduced as compared with the case in which the recording device is the laser type. Therefore, when the recording device is replaced with another recording device of a different recording type in the ink-jet type and the laser type, the medium can be appropriately placed on the placement part according to the recording type of the recording device after the replacement without replacing the post-processing device.

(D) A processing tray on which the medium to be subjected to the post-processing is loadable, and a rotary transport part configured to transport the medium loaded on the processing tray by rotating in contact with the medium loaded on the processing tray may be included, and when the first information is acquired, the controller may increase an amount of rotation of the rotary transport part as compared with the case in which the second information is acquired.

According to this configuration, when the recording type of the recording device is the ink-jet type, it is possible to increase the amount of rotation of the rotary transport part configured to transport the medium loaded on the processing tray as compared with the case in which the recording device is the laser type. Thus, when the recording device is replaced with another recording device of a different recording type in the ink-jet type and the laser type, the medium loaded on the processing tray can be appropriately transported according to the recording type of the recording device after the replacement without replacing the post-processing device.

(E) A processing tray on which the medium to be subjected to the post-processing is loadable may be included, when the first information is acquired as information configured to determine a reception interval at which the medium is receivable by the reception part, the controller may be configured to transmit, to the recording device, information configured to determine a longer interval than in the case in which the second information is acquired, and when the first information is acquired, the controller may increase a processing interval of the post-processing as compared with the case in which the second information is acquired.

According to this configuration, when the recording type of the recording device is the ink-jet type, the information configured to determine the longer reception interval than in the case in which the recording type is the laser type can be transmitted to the recording device. That is, when the recording type of the recording device is the ink-jet type, the processing interval of the post-processing may be increased as compared with the case in which the recording type is the laser type. Therefore, when the recording device is replaced with another recording device of a different recording type in the ink-jet type and the laser type, the post-processing can be performed appropriately according to the recording type of the recording device after the replacement without replacing the post-processing device. In addition, when the ink-jet type recording device is replaced with the laser type recording device, the post-processing according to the laser type recording device can be performed without replacing the post-processing device, and a decrease in efficiency of the post-processing can be prevented.

(F) A drying mechanism configured to dry the medium transported to the post-processing part may be included, and the controller may dry the medium transported to the post-processing part with the drying mechanism when the first information is acquired and may not dry the medium transported to the post-processing part with the drying mechanism when the second information is acquired.

According to this configuration, when the recording type of the recording device is the ink-jet type, the medium transported to the post-processing part can be dried by the drying mechanism. Thus, when the recording device is replaced with another recording device of a different recording type in the ink-jet type and the laser type, the moisture contained in the medium transported to the post-processing part can be adjusted according to the recording type of the recording device after the replacement without replacing the post-processing device. Therefore, the post-processing can be appropriately performed. In addition, when the ink-jet type recording device is replaced with the laser type recording device, the medium transported to the post-processing part is not dried by the drying mechanism without replacing the post-processing device, and unnecessary energy is not consumed.

(G) The post-processing part may perform a punching process of punching the medium as the post-processing, and when the first information is acquired, the controller may perform at least one of control of increasing a punching speed of the punching process and control of increasing the number of punching times of the punching process as compared with the case in which the second information is acquired.

According to this configuration, when the recording type of the recording device is the ink-jet type, it is possible to perform at least one of the control of increasing the punching speed of the punching process and the control of increasing the number of punching times in the punching process, as compared to the case in which the recording type is the laser type. Therefore, when the recording device is replaced with another recording device of a different recording type in the ink-jet type and the laser type, the punching processing can be appropriately performed according to the recording type of the recording device after the replacement without replacing the post-processing device. In addition, when the ink-jet type recording device is replaced with the laser type recording device, the punching process according to the laser type recording device can be performed without replacing the post-processing device, and the decrease in the efficiency of the post-processing can be prevented.

(H) A processing tray on which the medium to be subjected to the post-processing is loadable, and an air blowing part configured to blow air from above the processing tray to the medium loaded on the processing tray may be included, and the controller may cause the air blowing part to blow air when the first information is acquired and may not cause the air blowing part to blow air when the second information is acquired.

According to this configuration, when the recording type of the recording device is the ink-jet type, the air blowing part can blow air to the medium. Thus, when the recording device is replaced with another recording device of a different recording type in the ink-jet type and the laser type, it is possible to change whether or not the air blowing part is caused to blow air according to the recording type of the recording device after the replacement without replacing the post-processing device. Therefore, it is possible to suppress curling of the medium after recording that is loaded on the processing tray, and thus the post-processing can be performed appropriately.

(I) A first transport path configured to transport the medium before the post-processing, and a second transport path configured to transport the medium before the post-processing may be included, the first transport path may have a longer path length than the second transport path, and the controller may transport the medium before the post-processing to the first transport path when the first information is acquired and may transport the medium before the post-processing to the second transport path when the second information is acquired.

According to this configuration, when the recording type of the recording device is the ink-jet type, the medium before the post-processing can be transport to the first transport path having a longer path length than the second transport path. When the recording type of the recording device is the laser type, the medium before the post-processing is performed can be transported to the second transport path. Thus, when the recording device is replaced with another recording device of a different recording type in the ink-jet type and the laser type, the path length for transporting the medium before the post-processing is performed can be adjusted according to the recording type of the recording device after the replacement without replacing the post-processing device. Therefore, the time for drying the medium before the post-processing can be adjusted, and the post-processing can be performed appropriately. In addition, when the ink-jet type recording device is replaced with the laser type recording device, the medium can be transported to the second transport path according to the laser type recording device without replacing the post-processing device, and the decrease in the efficiency of the post-processing can be prevented.

(J) A waiting part configured to cause the medium before the post-processing is performed to wait may be included, and the controller may cause the medium before the post-processing is performed to wait in the waiting part when the first information and may not cause the medium before the post-processing is performed to wait in the waiting part when the second information is acquired.

According to this configuration, when the recording type of the recording device is the ink-jet type, the medium before the post-processing is performed can be caused to wait in the waiting part. When the recording type of the recording device is the laser type, the medium before the post-processing is performed is not caused to wait in the waiting part. Thus, when the recording device is replaced with another recording device of a different recording type in the ink-jet type and the laser type, it is possible to adjust whether or not the medium before the post-processing is performed is caused to wait in the waiting part according to the recording type of the recording device after the replacement without replacing the post-processing device. Therefore, the time for drying the medium before the post-processing is performed can be adjusted, and the post-processing can be performed appropriately. In addition, when the ink-jet type recording device is replaced with the laser type recording device, the medium is not caused to wait in the waiting part according to the laser type recording device without replacing the post-processing device, and the decrease in the efficiency of the post-processing can be prevented.

(K) The controller may acquire any one of the first information and the second information when power of the post-processing device is turned on.

According to this configuration, when power of the post-processing device is turned on, it is possible to determine whether the recording type of the recording device is the ink-jet type or the laser type, and thus the post-processing can be performed appropriately according to the recording type of the recording device after power of the post-processing device is turned on. Further, after power of the post-processing device is turned on, it is possible to reduce a processing time for performing the control of the post-processing as compared with a case in which any one of the first information and the second information is acquired for each post-processing.

(L) The controller may acquire model information configured to determine a model of the recording device as the information of the recording device, and the controller may perform the control of at least the post-processing based on the acquired model information.

According to this configuration, the model information configured to determine the model of the recording device can be acquired in addition to whether the recording type of the recording device is the ink-jet type or the laser type, and the control of at least the post-processing can be performed based on the model information. Therefore, when the recording device is replaced with another recording device of a different recording type, the post-processing can be performed appropriately according to the model of the recording device after the replacement without replacing the post-processing device.

(M) The controller may acquire recording density information configured to determine a recording density on the medium by the recording device as the information of the recording device when the first information is acquired, and the controller may not acquire the recording density information when the second information is acquired and may perform the control of at least the post-processing based on the acquired recording density information when the first information is acquired.

According to this configuration, when the recording type of the recording device is the ink-jet type, the control of at least the post-processing can be performed based on the recording density on the medium that serves as an indicator of the control of the post-processing. Therefore, when the laser type recording device is replaced with the ink-jet type recording device, the post-processing can be performed appropriately according to the recording density by the ink-jet type recording device without replacing the post-processing device. In addition, when the recording type of the recording device is the laser type, the recording density on the medium that does not serve as an indicator of the control of the post-processing is not acquired, and the control of at least the post-processing can be performed. Therefore, when the ink-jet type recording device is replaced with the laser type recording device, the processing time for performing the control of the post-processing can be reduced and the post-processing can be performed appropriately without replacing the post-processing device.

(N) The post-processing part may perform a punching process of punching the medium as the post-processing, and the controller may transmit, to the recording device, information configured to determine restriction of recording in at least a punching region on the medium when the first information is acquired.

According to this configuration, when the recording type of the recording device is the ink-jet type, it is possible to transmit the information configured to determine the restriction of the recording in at least the punching region on the medium. Thus, when the recording type of the recording device is the ink-jet type, the restriction of the recording in at least the punching region on the medium can be determined in the recording device. Therefore, when the laser type recording device is replaced with the ink-jet type recording device, the recording in at least the punching region on the medium can be restricted according to the ink-jet type recording device and the punching processing can be performed appropriately without replacing the post-processing device.

(O) A recording device configured to perform recording on a medium, and a post-processing device configured to receive the medium on which the recording was performed by the recording device are provided, wherein the post-processing device includes a reception part configured to receive the medium on which recording was performed by the recording device, a post-processing part configured to perform post-processing on the medium received by the reception part, and a controller configured to perform control of at least the post-processing, the controller is configured to acquire, as information of the recording device, first information configured to determine that a recording type of the recording device is an ink-jet type, and second information configured to determine that the recording type of the recording device is a laser type, and the controller performs the control of at least the post-processing based on whether the first information is acquired or the second information is acquired. According to this configuration, the same effect as in (A) above can be obtained.

(P) The post-processing device may include a processing tray on which the medium to be subjected to the post-processing is loadable, the recording device may include a recording part configured to perform recording on a medium, a recording controller configured to perform control of the recording on the medium, a paper feed mechanism configured to feed a medium to by the recording part, and a recording transport mechanism configured to transport the medium on which recording was performed by the recording part, and when the recording type of the recording device is an ink-jet type, the recording controller may perform at least any one of control of increasing a paper feed interval of the medium by the paper feed mechanism and control of reducing a transport speed of the medium by the recording transport mechanism as compared with a case in which the recording type of the recording device is a laser type. According to this configuration, the same effect as in (E) above can be obtained.

(Q) The recording device may include a recording part configured to perform recording on the medium, and a recording controller configured to perform control of the recording on the medium, and the recording controller may restrict the recording in at least a punching region on the medium when the recording type of the recording device is the ink-jet type. According to this configuration, the same effect as in (N) above can be obtained.

What is claimed is:

1. A post-processing device comprising:
a reception part configured to receive a medium on which recording was performed by a recording device;
a post-processing part configured to perform post-processing on the medium received by the reception part; and
a controller configured to perform control of at least the post-processing; wherein
the controller is configured to acquire, as information of the recording device, first information configured to determine that a recording type of the recording device is an ink-jet type, and second information configured to determine that the recording type of the recording device is a laser type, and
the controller is configured to acquire the information of the recording device, to perform post-processing based on a first setting when the information of the recording device includes the first information configured to determine that the recording type is the ink-jet type, and to perform control of post-processing based on a second setting different from the first setting when the information of the recording device includes the second information configured to determine that the recording type is the laser type.

2. The post-processing device according to claim 1, wherein
the post-processing part is configured to perform a binding process that binds a plurality of sheets of the medium as the post-processing, and the controller is configured to, when the first information is acquired, reduce an upper limit of the number of sheets of the medium to be bound by the binding process as compared with a case in which the second information is acquired.

3. The post-processing device according to claim 1, comprising a placement part on which the medium after the post-processing is placeable; wherein
the controller is configured to, when the first information is acquired, reduce an upper limit of the number of sheets of the medium placeable on the placement part as compared with a case in which the second information is acquired.

4. The post-processing device according to claim 1, comprising:
a processing tray on which the medium to be subjected to the post-processing is loadable; and
a rotary transport part configured to transport the medium loaded on the processing tray by rotating in contact with the medium loaded on the processing tray; wherein
the controller is configured to, when the first information is acquired, increase an amount of rotation of the rotary transport part as compared with a case in which the second information is acquired.

5. The post-processing device according to claim 1, comprising:
a processing tray on which the medium to be subjected to the post-processing is loadable; wherein
the controller is configured to, when the first information is acquired as information configured to determine a reception interval at which the medium is receivable by the reception part, transmit, to the recording device, information configured to determine a longer interval than in a case in which the second information is acquired, and
the controller is configured to, when the first information is acquired, increase a processing interval of the post-processing as compared with a case in which the second information is acquired.

6. The post-processing device according to claim 1, comprising a drying mechanism configured to dry the medium transported to the post-processing part, wherein
the controller is configured to dry the medium transported to the post-processing part with the drying mechanism when the first information is acquired, and is configured not to dry the medium transported to the post-processing part with the drying mechanism when the second information is acquired.

7. The post-processing device according to claim 1, wherein
the post-processing part is configured to perform a punching process of punching the medium as the post-processing, and
the controller is configured to, when the first information is acquired, perform at least one of control of increasing a punching speed of the punching process and control of increasing the number of punching times of the punching process as compared with a case in which the second information is acquired.

8. The post-processing device according to claim 1, comprising:
a processing tray on which the medium to be subjected to the post-processing is loadable; and
an air blowing part configured to blow air from above the processing tray to the medium loaded on the processing tray; wherein
the controller is configured to cause the air blowing part to blow air when the first information is acquired, and is configured not to cause the air blowing part to blow air when the second information is acquired.

9. The post-processing device according to claim 1, comprising:
a first transport path configured to transport the medium before the post-processing is performed; and
a second transport path configured to transport the medium before the post-processing is performed; wherein
the first transport path has a longer path length than the second transport path, and
the controller is configured to transport the medium before the post-processing is performed to the first transport path when the first information is acquired and is configured to transport the medium before the post-processing is performed to the second transport path when the second information is acquired.

10. The post-processing device according to claim 1, comprising a waiting part configured to cause the medium before the post-processing is performed to wait;
wherein the controller is configured to cause the medium before the post-processing is performed to wait in the waiting part when the first information is acquired and is configured not to cause the medium before the post-processing is performed to wait in the waiting part when the second information is acquired.

11. The post-processing device according to claim 1, wherein the controller is configured to acquire any one of the first information and the second information when power of the post-processing device is turned on.

12. The post-processing device according to claim 1, wherein the controller is configured to acquire model information configured to determine a model of the recording device as the information of the recording device, and
the controller is configured to perform the control of at least the post-processing based on the acquired model information.

13. The post-processing device according to claim 1, wherein the controller is configured to acquire recording density information configured to determine a recording density on the medium by the recording device as the information of the recording device when the first information is acquired, and is configured not to acquire the recording density information when the second information is acquired, and
the controller is configured to perform the control of at least the post-processing based on the acquired recording density information when the first information is acquired.

14. The post-processing device according to claim 1, wherein the post-processing part is configured to perform a punching process of punching the medium as the post-processing, and
the controller is configured to transmit, to the recording device, information configured to determine restriction of recording in at least a punching region on the medium when the first information is acquired.

15. A recording system comprising:
a recording device configured to perform recording on a medium; and
a post-processing device configured to receive the medium on which the recording was performed by the recording device; wherein
the post-processing device includes a reception part configured to receive the medium on which the recording was performed by the recording device, a post-processing part configured to perform post-processing on the medium received by the reception part, and a controller configured to perform control of at least the post-processing,
the controller is configured to acquire, as information of the recording device, first information configured to determine that a recording type of the recording device is an ink-jet type, and second information configured to determine that the recording type of the recording device is a laser type, and
the controller is configured to perform the control of at least the post-processing based on whether the first information is acquired or the second information is acquired.
